(19) United States
(12) Patent Application Publication
(10) Pub. No.: US 2009/0202672 A1
(43) Pub. Date: Aug. 13, 2009

(54) AQUACULTURE FEED, PRODUCTS, AND METHODS COMPRISING BENEFICIAL FATTY ACIDS

(75) Inventor: Gary F. Hartnell, St. Peters, MO (US)

Correspondence Address: Armstrong Teasdale LLP (29135);Christopher M. Goff, One Metropolitan Square, Suite 2600, St. Louis, MO, 63102-2740, US

(73) Assignee: Monsanto Company, St. Louis, MO (US)

(21) Appl. No.: 12/362,278

(22) Filed: Jan. 29, 2009

Related U.S. Application Data
(60) Provisional application No. 61/027,647, filed on Feb. 11, 2008.

(51) Int. Cl. A23K 1/18; A23L 1/30

(52) U.S. Cl. 426/2; 426/72

(57) ABSTRACT

Embodiments of the present invention provide improved aquaculture products and methods of producing such aquaculture products by incorporating healthier lipids containing stearidonic acid and gamma linolenic acid into the aquaculture feed. This in turn improves the health profile of the aquatic animals promoting growth and limiting commercial losses. Furthermore, embodiments of the present invention provide methods for producing said products. In one embodiment of the invention, an aquaculture animal may be fed a feed comprising a transgenic plant product. In other embodiments of the invention, cold water fish meat, warm water fish meat, and crustacean meat products comprising SDA, GLA, EPA, and DHA are disclosed. In further embodiments of the invention, other aquaculture feed products comprising SDA, and GLA are disclosed.

### CROSS REFERENCE TO RELATED APPLICATIONS

This patent application claims priority from U.S. Provisional Patent Application 61/027,647 filed on Feb. 11, 2008, the entire contents of which is incorporated herein by reference.

### FIELD OF THE INVENTION

Embodiments of the present invention relate to the enhancement of desirable characteristics in aquaculture or aquaculture products through the incorporation of beneficial fatty acids in aquaculture feed or feed supplements. More specifically, it relates to methods of production and processing of aquaculture products for use as feed, comprising polyunsaturated fatty acids including stearidonic acid.

### BACKGROUND OF THE INVENTION

The aquaculture feeds industry consumes, worldwide about 75% of the current total global fish oil production, up from about 15% 12 years ago. It is forecasted that by 2010, increasing aquaculture production will exhaust existing global fish oil supplies and will demand an additional 380,000 tons of oil from other sources on an annual basis. Estimates by NOAA indicate that domestic aquaculture production of all species could increase from about a half million tons annually to 1.5 million tons a year by 2025. Currently, most of the fish oil used in aquaculture feed is produced from anchovetta fish found off Peru and Northern Chile, anchovy along the Mexican and Central American Pacific coasts as well as menhaden from the US Gulf and Atlantic coasts. These industrial fisheries are presently harvested at sustainable levels but the growth of oil production from these sources is unlikely without risking the underlying fisheries and ecosystems involved themselves. Hence, there is significant interest in finding a renewable alternative to wild caught fish oils, preferably one that can grow as global demand for fish products also increases.

One alternative is plant-based oils. These are land-based renewable resources that do not endanger marine ecosystems and remain, at least to some degree, scaleable. In particular, plant oils such as soybean and canola may be used as an alternative source to traditional fish oils. However, the fatty acid profile of these traditional commodity oils differs markedly from traditional fish oils and they do not meet the polyunsaturated omega-3 essential fatty acid dietary requirements for a range of marine, salmonid and coldwater fish. For example, while standard soybean oil contains high levels of omega-6 fatty acids in the form of linoleic acid (LA; 18:2Ω6), the commodity oils contain comparatively low levels of omega-3 polyunsaturated fatty acids such as α-linolenic acid (ALA; 18:3ω3) and no detectable amounts of stearidonic acid (SDA; 18:4ω3) or the highly-unsaturated fatty acids such as eicosapentaenoic (EPA; 20:5ω3) or docosahexaenoic acids (DHA; 22:6ω3), respectively. Given the economics of the marketplace, plant oils have occasionally been used to partially or to completely replace fish oil in diets for a range of fish species. Typically in the use of these traditional commodity oils no reduction in growth performance is observed when included in fish meal-based diets, where the oil contained within the fish meal by itself contained sufficient EPA and DHA to meet essential fatty acid requirements of the given species (Mugrditchian et al. 1981; Sargent et al. 2002; Bell et al. 2003; Bendiksen et al. 2003; Regost et al. 2003). Growth deficits are seen in those efforts where the “replacement” diet does not include sufficient EPA and DHA to meet essential fatty acid requirements of the given species.

With the reduction in availability of wild caught fish stocks on an international level, and a growing demand for fish based products there is a necessity to enhance the production of fish through the use of renewable and expandable resources. According to the current invention this can be accomplished with the use of aquaculture feed produced from sustainable agricultural resources if they are modified to produce,plant-based oils that contain increased levels of omega-3 fatty acids such as ALA and SDA.

SDA is an important metabolic intermediate between ALA and EPA in the poly unsaturated fatty acid (“PUFA”) biosynthetic pathway. SDA is found in fish oil at levels of up to 4% as well as in plants such as evening primrose, echium, and black currant. According to the current invention the use of transgenic technology and its application to oilseed crops has allowed the development of plants that can produce significant concentrations of omega-3 fatty acids. These concentrations of PUFA's are at much greater concentrations than those seen in wild type seeds (Ursin 2003), even in plant species that can actually produce these long-chain fatty acids. In particular it should be noted that the SDA content in oil from non-transgenic soybeans is essentially zero. According to the transgenic soybeans of the current invention the SDA content of transgenically modified soybean oil may be up to 30% of the total fatty acid content and carries with it an identifiable composition useful in the feeding of aquatic animals of interest as food, feed and the source of industrial products.

As has been noted, SDA has the potential to be used as a dietary fatty acid source to meet essential fatty acid requirements in humans. In fact, Ursin (2003) reported that unlike dietary ALA, dietary SDA provides EPA equivalence at moderate intake levels in humans. James et al (2003) concluded that SDA was more than 3 times more efficiently metabolized to tissue EPA in humans than ALA. The conversion rate of SDA to EPA in fish appears to be species dependent. Ghioni et al (1999) reported a low C18 to C20 fatty acid elongase activity and a limited conversion of SDA to EPA in a cell line from turbot, Scopthalmus maximus. Ghioni et al (2004) demonstrated the bioconversion of SDA to EPA, but not DHA, in an established cell line from Atlantic salmon, Salmo salar. It is also known that Rainbow trout are capable of synthesizing EPA de novo from ALA (Hardy 2002). However, the desaturation and chain elongation processes in the PUFA biosynthesis pathway in fish appears to be rate limited and as a result optimum growth in rapidly growing cultured fish may not be achieved in the absence of exogenous dietary EPA or DHA. In contrast, and according to the current invention, the inclusion of dietary SDA for rainbow trout could lead to more efficient biosynthesis of EPA, and ultimately a faster growing and healthier fish that is a more healthful product for human consumption. It should be noted that many techniques important to the industry are in the health sector and are designed to improve animal health with the eventual goal of improving yield. These include plating samples of water and tissue on agar plates to test for bacteria and fungi, the use of electron microscopy and DNA based “probes” to check for viruses, the use of “probiotics” or “friendly” bacteria to keep water in good condition.

The present invention is directed to a method for improving aquaculture, methods for the improvement of the tissues and/or the meat, and other aquaculture products and derivatives produced from aquatic species through the utilization of transgenic plant-derived stearidonic acid (“SDA”) or SDA oil in aquaculture feed. Specifically, the inventors provide techniques and methods for the utilization of transgenic plant-derived SDA compositions in feed products that improve the nutritional quality of aquaculture derived products or in the productivity of the aquaculture animals themselves.

Many studies have made a physiological link between dietary fats and pathologies such obesity and atherosclerosis. In some instances, consumption of fats has been discouraged by the medical establishment. More recently, the qualitative differences between dietary fats and their health benefits have been recognized.

Recent studies have determined that despite their relatively simple biological structures there are some types of fats that appear to improve body function in some ways and that may, in fact, be essential to certain physiological processes. The wider class of fat molecules includes fatty acids, isoprenols, steroids, other lipids and oil-soluble vitamins. Among these are the fatty acids. The fatty acids are carboxylic acids, which have from 2 to 26 carbon atoms in their “backbone,” with none or few desaturated sites in their carbohydrate structure. They generally have dissociation constants (pKa) of about 4.5 indicating that in normal body conditions (physiological pH of 7.4) the vast majority will be in a dissociated form.

With continued experimentation workers in the field have begun to understand the nutritional need for fats and in particular fatty acids in the diet. For this reason, many in the food industry have begun to focus on fatty acids and lipid technology as a new focus for food production, with its consequent benefits for the aquaculture animals consuming the modified feed and in products derived from those aquaculture animals for human consumption.

This focus has been particularly intense for the production and incorporation of Omega-3 fatty acids into the diet. Omega-3 fatty acids are long-chain polyunsaturated fatty acids (18-22 carbon atoms in chain length) with the first of the double bonds (“unsaturations”) beginning with the third carbon atom from the methyl end of the molecule. They are called “polyunsaturated” because their molecules have two or more double bonds “unsaturations” in their carbohydrate chain. They are termed “long-chain” fatty acids since their carbon backbone has at least 18 carbon atoms. In addition to stearidonic acid “SDA” the omega-3 family of fatty acids includes alpha-linolenic acid (“ALA”), eicosatetraenoic acid (ETA), eicosapentaenoic acid (“EPA”), docosapentaenoic acid (DPA), and docosahexaenoic acid (“DHA”). ALA can be considered a “base” omega-3 fatty acid, from which EPA and DHA are made in the body through a series of enzymatic reactions, including the production of SDA. Most nutritionists point to DHA and EPA as the most physiologically important of the Omega-3 fatty acids with the most beneficial effects. However, SDA has also been shown to have significant health benefits. See for example, U.S. Pat. No. 7,163,960 herein incorporated by reference.

The synthesis processes from ALA is called “elongation” (the molecule becomes longer by incorporating new carbon atoms) and “desaturation” (new double bonds are created), respectively. In nature, ALA is primarily found in certain plant leaves and seeds (e.g., flax) while EPA and DHA mostly occur in the tissues of cold-water predatory fish (e.g., tuna, trout, sardines and salmon), and in some marine algae or microbes that they feed upon.

Along with the movement of food companies to develop and deliver essential fats and oils as an important component in a healthy human diet, governments have begun developing regulations pushing for the adoption of PUFA's in the diet. The difficulty in supplying these needs has been the inability to develop a large enough supply of Omega-3 oil to meet growing marketplace demand. As already mentioned, the Omega-3 fatty acids commercially deemed to be of highest value, EPA and DHA, also chemically oxidize very quickly over time limiting commercial availability. Importantly, during the rapid process of EPA and DHA degradation these long chain fatty acids develop rancid and profoundly unsatisfactory sensory properties that make their inclusion in many foodstuffs difficult or impossible from a commercial acceptance perspective. In addition, with increased demand for Omega-3 fatty acids has come the realization that already depleted global fish stocks cannot meet any significant growth in future human and animal nutritional needs for Omega-3's. These limitations on supply, stability and sourcing greatly increase cost and correspondingly limit the availability of dietary Omega-3's.

Suboptimal nutrition is a limiting factor in aquatic animal productivity. Basic information regarding this process in commercially important aquaculture animals is lacking. New knowledge in this area is needed to improve aquaculture animal production and control and enhance meat quality, growth, reproductive capacity and metabolism. Research is also needed to identify biological mechanisms for increasing dietary nutrient availability, enhancing nutrient composition in aquaculture animal products, and minimizing excretion of nutrients as waste products. It is also desirable to develop a system that is capable of determining if a particular feed is useful in enhancing aquaculture animal productivity. Examples of suitable evaluation criteria include a feed cost per unit weight gain basis, a production rate basis (e.g., based upon a rate of aquaculture animal weight gain or a rate of production of an aquaculture animal product), and a feed amount per unit of weight gain basis.

Accordingly a need exists to enhance the productivity, health and growth characteristics of aquaculture animals where long change omega-3 fatty acids found in marine sources of fish or algae are missing in the diet, including farm-raised aquaculture animals. The SDA compositions of the current invention not only provide needed dietary fat for energy for specific aquaculture animal species, but also provide other dietary improvements such as specific long chain omega-3 fatty acid required for the commercial production of aquaculture animals. The feed compositions of embodiments of the current invention comprise SDA compositions that can be used in producing an enhanced feed or feed supplement for aquaculture containing the SDA.

In addition, a need exists to provide a consumer acceptable means of delivering omega-3 fatty acids such as SDA, EPA, and DHA or critical precursors in food formulations in a commercially acceptable way. The current invention provides an alternative to fish or algae or microbe supplied omega-3 fatty acids in the form of aquaculture meat and other aquaculture products comprising beneficial omega-3 fatty acids and does so utilizing a comparatively chemically stable Omega-3 fatty acid, SDA, as a source that offers improved cost-effective production and abundant supply as derived from transgenic plants. The delivery of these plant-derived Omega-3s reduces overall costs and specifically limits the need for as much fish oil and/or fishmeal as has been traditionally used in the field.

According to embodiments of the current invention, the preferred plant species that could be modified to reasonably supply demand are: soybeans, corn, and canola, but many other plants could also be included as needed and as scientifically practicable. Once produced, the SDA of the invention can be used to improve the health characteristics of a great variety of food products. This production can also be scaled-up as needed to both reduce the need to harvest wild fish stocks and to provide essential fatty acid (FA) components for aquaculture operations, each greatly easing pressure on global fisheries. The overall effect being to ease the pressure on natural fisheries while enabling the growth of aquaculture products.

Previous attempts to increase the concentration of beneficial fatty acids in aquaculture have included supplementing the diet of the aquaculture with ALA, EPA, or DHA. Omega-3 fatty acids have been investigated as a potential way to improve performance and meat quality in pigs and other animals. In the literature, some trials indicated positive responses and others indicated no response in growth to omega-3 FA. The disparity of growth performance response in aquatic animals was largely due to differences in source of the omega-3 FA and in the other dietary FA present as well as the stage of life of the fish and species of fish (i.e., marine versus freshwater). In reviewing the previous research, it was apparent that under extreme immune pressure or with very young fish/fingerlings the likelihood of a positive growth response to omega-3 FA was increased. The immune data suggest that a balanced omega-3 and omega-6 FA diet provides for the optimal immune function.

Some attempts at incorporation of omega-3 fatty acids into aquaculture products have been described in the art. However, existing methods include addition of highly unstable EPA or DHA in the form of fish oil or algae which are less stable and more difficult to obtain; or incorporation of traditional omega-3 fatty acids such as ALA, which are not converted to the beneficial forms efficiently enough to be commercially practical. Nutritional studies have shown that, compared to alpha-linolenic acid, SDA is 3 to 4 times more efficiently converted in vivo to EPA in humans, thus requiring a much lower volume in order to achieve the same level of conversion. (Ursin, 2003).

Some attempts at incorporation of omega-3 fatty acids into aquaculture feeds including SDA have been made using rare and expensive sources of SDA such as Echium oil (Bell et aL, 2006; Miller et aL, 2007). Embodiments of the present invention employ improved fatty acid compositions in comparison with previous efforts, as well as much more economical and scalable methods of production; namely, the application of transgenic soybean oil comprising SDA.

Surprisingly, the inventors have found that feeding fish and other aquatic animals the SDA compositions of the invention from transgenic plant sources are highly effective in increasing the omega-3 fatty acid levels of SDA (18:4), ETA (omega-3 20:4), EPA (eicosapentaenoic acid), DPA (docosapentaenoic acid), DHA (docosahexaenoic acid) while acting to actually decrease the levels of the omega-6 fatty acids ARA (arachidonic acid), and docosatetraenoic acid (DTA, omega-6 22:4). Thereby improving the omega-6 to omega-3 fatty acid ratio as compared to feeding vegetable oils such as soybean oil in such animals. This activity may improve the overall health profile of aquaculture animals, allowing them to grow faster and improving their tissues for the production of aquaculture products for human use or consumption, especially in species which require long chain PUFA's in their diets.

An improved ratio of omega-3 fatty acids in aquaculture meat can also be achieved through feeding aquaculture animals fish oil comprising SDA, EPA, and DHA. However, the literature describes that such products are associated with undesirable side affects such as stability and taste and smell properties as well as vastly increased cost. The side effects and the costs of using fish oil in aquaculture make this option largely impracticable on a commercial level. According to the current invention, through the use of SDA, adverse taste, smell, and stability were not observed in the methods and products of the present invention. SDA feed comprising whole foods, unlike the omega-3 fatty acids commonly described in the literature, is uniquely suited for feed compositions which yield healthy and stable aquaculture products. Plant-based sources of DHA, EPA and SDA can also be provided in a way so as to provide relatively cheap plant-based protein as part of the diet of aquatic animals as well. According to another embodiment of the current invention an oilseed crop transgenically designed to produce Omega-3 fatty acids can be crushed and the oil taken, the resulting meal will still contain some transgenic oil and may be a good source of omega-3 oil on its own and will also provide plant proteins for the diet of aquatic animals (e.g., soy meal comprising SDA oil with significant soy protein).

A further advantage of feeding SDA over alpha linolenic acid (ALA) is that SDA circumvents the limiting reaction of the delta-6 desaturase and is therefore much more efficiently converted to the long chain PUFA's EPA, DPA, and DHA.

### SUMMARY OF THE INVENTION

Embodiments of the present invention encompass incorporation of oil from transgenic plants engineered to contain significant quantities of stearidonic acid (18:4Ω3) for use in aquaculture feed to improve the fatty acid profile of aquaculture animals, improved health profile of aquaculture raised aquatic animals, aquaculture products derived therefrom and/or the health of an end consumer.

Sufficient quantities of SDA enriched soybeans have been grown to allow the delivery of soybeans and soy oil with a substantial SDA component. According to embodiments of the current invention, the SDA soybeans of the invention provide enhanced nutritional quality relative to traditional omega-3 alternatives such as flaxseed and lack negative taste and low stability characteristics associated with fish oil. Therefore, a preferred embodiment of this invention comprises an aquaculture product with an increased level of beneficial polyunsaturated fatty acids such as SDA, GLA, DGLA, EPA, ETA, DPA, and DHA. Surprisingly, significant amounts of SDA were incorporated into the aquaculture meat through feed supplemented with SDA and some of this SDA was converted to longer chain fatty acids such as EPA and DHA.

Also according to the current invention, testing of aquaculture diets comprising stearidonic acid has also been conducted and the plant-derived SDA feed has substantially improved the fatty acid profile of the resulting aquaculture products. Therefore, a preferred embodiment of the current invention is the usage of the SDA oil produced by transgenic plants in the production of aquaculture feed.

Embodiments of the invention also include aquaculture meat products comprising tissue from an aquaculture animal having stearidonic acid (SDA), eicosapentaenoic acid (EPA), gamma linolenic acid (GLA) and docosahexaenoic acid (DHA) wherein: the concentration of SDA is at least about 25 mg/100 g tissue, the concentration of the GLA is at least about 25 mg/100 g tissue, the concentration of the EPA is at least about 15 mg/100 g tissue, and the concentration of the DHA is at least about 30 mg/100 g tissue.

Embodiments of the invention also include methods of producing a aquaculture product comprising: providing a stearidonic acid source comprising stearidonic acid (SDA), providing additional feed components, contacting the stearidonic acid source with the feed components to make a supplemented feed, feeding the supplemented feed to a plurality of aquaculture animals, and harvesting at least one edible product from the aquaculture animals, wherein the stearidonic acid source comprises a transgenic plant source and wherein at least a portion of the SDA is incorporated into the edible product.

Embodiments of the invention also include aquaculture feed comprising stearidonic acid (SDA), gamma linolenic acid (GLA), and additional feed components, wherein the aquaculture feed comprises at least about 0.5% stearidonic acid and at least about 0.1% GLA, wherein the ratio of SDA/GLA is about 1.3.

Embodiments of the invention also include fish derivatives comprising stearidonic acid (SDA), eicosapentaenoic acid (EPA), gamma linolenic acid (GLA) and docosahexaenoic acid (DHA) wherein: the concentration of SDA is at least about 3.0 g/100 g fatty acids, the concentration of the GLA is at least about 1.5 g/100 g fatty acids, the concentration of the EPA is at least about 0.5 g/100 g fatty acids, and the concentration of the DHA is at least about 3.0 g/100 g fatty acids.

Embodiments of the invention also include fish meat products comprising at least about 3.5 g of stearidonic acid (SDA) per 100 g fatty acid and at least about 0.5 g of DGLA per 100 g fatty acid.

Embodiments of the invention also include aquaculture feed comprising a fish derivative, and stearidonic acid (SDA), wherein the aquaculture feed comprises at least about 0.5% SDA and at least about 0.3% GLA, wherein the ratio of SDA/GLA is about 1.3. to 4.0 and wherein the SDA is derived from a transgenic plant.

Embodiments of the invention also include methods of producing an aquaculture product comprising: providing a fish derivative, feeding the fish derivative to a plurality of aquaculture animals, and harvesting at least one aquaculture product from the aquaculture animals, wherein the fish derivative is an oil or meal derived from a fish which is fed feed comprising stearidonic acid from a transgenic plant source.

Embodiments of the invention also include methods of raising a fish comprising: providing a feed comprising a fish derivative, feeding the fish derivative to a plurality of fish, and wherein the fish derivative comprises SDA, GLA, and DGLA and wherein the concentration of GLA is at least about 0.5 g/100 g fatty acids, the concentration of SDA is at least about 3.0 g/100 g fatty acid, and the concentration of DGLA is at least about 0.3 g/100 g fatty acid.

Embodiments of the invention also include methods of producing a fish comprising: providing a feed comprising a fish derivative, feeding the fish derivative to a plurality of fish, and wherein the fish derivative comprises SDA, GLA, and linoleic acid (LA) and wherein the ratio of concentrations of GLA/LA is at least about 0.05.

Embodiments of the invention also include fish derivatives comprising stearidonic acid (SDA), eicosapentaenoic acid (EPA), gamma linolenic acid (GLA), dihomo-gamma-linolenic acid (DGLA), linoleic acid (LA) and docosahexaenoic acid (DHA) wherein: the ratio of concentrations of GLA/LA is at least about 0.1; and the concentration of DGLA is at least about 0.5 g/100 g fatty acids.

Embodiments of the invention also include methods of producing a crustacean comprising: providing a feed comprising stearidonic acid (SDA) source, feeding the SDA source to a plurality of crustacean, and wherein the SDA source comprises SDA and GLA, and wherein the SDA source comprises a transgenic vegetable oil.

In an additional embodiment of the invention, aquaculture products comprising SDA and DHA are disclosed including aquaculture meat and other aquaculture products. Furthermore, methods of making such products are disclosed.

In an additional embodiment of the invention, aquaculture products comprising SDA, EPA, and DHA are disclosed. Furthermore, methods of making such products are disclosed. These methods may include providing a stearidonic acid source comprising SDA, providing additional feed components, contacting said stearidonic acid source with said feed components to make a supplemented feed, feeding said supplemented feed to a plurality of aquaculture animals, harvesting at least one edible product for human consumption from said aquaculture animals, wherein said stearidonic acid source comprises a transgenic plant source, and wherein some portion of said SDA is incorporated in said edible product.

In an additional embodiment of the invention, aquaculture products comprising SDA, EPA, and DHA are disclosed. Furthermore, methods of making such products are disclosed. These methods may include providing a stearidonic acid source comprising SDA, providing additional feed components, contacting said stearidonic acid source with said feed components to make a supplemented feed, feeding said supplemented feed to a plurality of aquaculture animals, harvesting at least a portion of said aquaculture animal tissue, wherein some portion of said harvested tissue is used as an animal feed or supplement.

In an additional embodiment of the invention, aquaculture products comprising SDA, EPA, and DHA are disclosed. Furthermore, methods of making such products are disclosed. These methods may include providing a stearidonic acid source comprising SDA as an additional feed component, such that this supplementation improves the health of the aquatic animals so fed. Typically, the high densities of fish held at aquaculture facilities can lead to increased levels of disease and parasites, SDA supplementation may improve animal health and in so doing reduce commercial losses and improving yield.

In an additional embodiment of the invention, products comprising SDA, EPA, and DHA and having reduced omega-6 content are disclosed. Furthermore, methods of making such products are disclosed.

According to a preferred embodiment of the invention, aquaculture products comprising minimum concentrations of fatty acids are described and provided. Preferably, the aquaculture meat product comprises a concentration of SDA at least about 30 mg per 100 g of meat, the concentration of EPA is at least about 50 mg and the concentration of DHA is at least about 150 mg per 100 g of meat of the aquaculture product. Preferably, the SDA concentration is at least about 30 mg/100 g meat, and more preferably 80 mg/100 g of meat the total fatty acid content of the aquaculture meat product.

In an additional embodiment of the invention, a food product for human consumption comprises an aquaculture product comprising SDA, EPA, GLA, DGLA, ETA, and DHA.

Other features and advantages of this invention will become apparent in the following detailed description of preferred embodiments of this invention, taken with reference to the accompanying figures.

### DEFINITIONS

The following definitions are provided to aid those skilled in the art to more readily understand and appreciate the full scope of the present invention. Nevertheless, as indicated in the definitions provided below, the definitions provided are not intended to be exclusive, unless so indicated. Rather, they are preferred definitions, provided to focus the skilled artisan on various illustrative embodiments of the invention.

As used herein the term “aquaculture product” refers to food or feed products comprising tissue from an aquaculture animal.

As used herein, the term “aquaculture meat product” refers to food or feed products comprising at least a portion of meat from an aquaculture animal.

As used herein, the term “fish derivative” refers to products composed primarily of fish tissues and/or lipids such as fish meat, fish oil, and fish meal. Fish derivatives may be processed, for example, by extraction, purification, rendering, grinding as known in the art.

As used herein, the term “warm water fish” refers to species of aquaculture animals typically found in warm water environments, such as for example carp, catfish, Cobia, Red Drum, Seam Bream, Yellowtail, Kona Kampachi (“Kahala”), Milkfish, bass, perch, and tilapia. In most cases, warm water fish do not require substantial amounts of omega 3 fatty acids in their natural diets.

As used herein, the term “coldwater fish” refers to species of aquaculture animals typically found in cold water environments, such as for example salmon, cod, Tuna (bluefin, bigeye, yellowfin), sea bass, Asian sea bass, Red sea bream, haddock, Gilt-head sea bream, Atlantic halibut, Japanese Flounder, North American flounder, Yellowtail, Red drum, Turbot, Mackerel, Herring, Sardines, Pilchards, Flounder, Sablefish, Shad, Artic Char, Wolffish, Sunfish, Sturgeon, Perch, Walleye, Northern, Bluegill, and trout species. Coldwater fish, especially oily coldwater fish found in marine environments such as salmon, Mackerel, Herring, Sardines, Pilchards, Sablefish, and shad, generally require substantial amounts of omega 3 fatty acids in their natural diets.

As used herein, the term “crustacean” refers to aquaculture animals of the subphylum crustacean including, for example, lobsters, crabs, shrimp, prawns, and crayfish.

As used herein, the term “shrimp product” refers to food or feed products comprising at least a portion of a shrimp or prawn.

“Aquaculture” or “aquaculture animal” refers to any species derived from saltwater or freshwater production, including coldwater and warm water species. Exemplary aquaculture animals include fish, shellfish, crustaceans, algae, and other aquatic organisms. Further non-limiting aquaculture animals include catfish, milkfish, salmon, trout, tuna, cobia, shrimp, kahala, prawns, crayfish, crabs, lobster, Asian carp, Atlantic Salmon, Barramundi, Bighead carp, Black carp, Catla, Common Carp, Grass carp, Gourami, Milkfish, Mudfish, Silver carp, Salmonids, Tilapia.

### DETAILED DESCRIPTION OF THE INVENTION

### Production of SDA:

Embodiments of the invention also include aquaculture meat products comprising tissue from an aquaculture animal having stearidonic acid (SDA), eicosapentaenoic acid (EPA), gamma linolenic acid (GLA) and docosahexaenoic acid (DHA) wherein: the concentration of SDA is at least about 25 mg/100 g tissue, the concentration of the GLA is at least about 25 mg/100 g tissue, the concentration of the EPA is at least about 15 mg/100 g tissue, and the concentration of the DHA is at least about 30 mg/100 g tissue.

Alternative embodiments include aquaculture meat products wherein the SDA concentration is at least about 25 mg/100 g tissue, 50 mg/100 g tissue, 75 mg/100 g tissue, 100 mg/100 g tissue, 150 mg/100 g tissue, 200 mg/100 g tissue, 250 mg/100 g tissue, 500 mg/100 g tissue or more. Alternative embodiments include aquaculture meat products wherein the GLA concentration is at least about 25 mg/100 g tissue, 50 mg/100 g tissue, 75 mg/100 g tissue, 100 mg/100 g tissue, 150 mg/100 g tissue, 200 mg/100 g tissue, 250 mg/100 g tissue, 500 mg/100 g tissue or more. Alternative embodiments include aquaculture meat products further comprising DGLA wherein the DGLA concentration is at least about 3 mg/100 g tissue, 5 mg/100 g tissue, 15 mg/100 g tissue, 25 mg/100 g tissue, 50 mg/100 g tissue, 100 mg/100 g tissue, 200 mg/100 g tissue, 500 mg/100 g tissue Alternative embodiments include aquaculture meat products wherein the ratio of concentrations of GLA/SDA is at least about 0.2, 0.3, 0.4, 0.5, 0.8, 1.0, 1.5, 2.0, 3.0 or more. Alternative embodiments include aquaculture meat products herein the ratio of concentrations of DGLA/SDA is at least about 0.05, 0.1, 0.2, 0.4, 0.5, or more. Alternative embodiments include aquaculture meat products herein the ratio of concentrations of EPA/SDA is less than about 2.0, 1.0, 0.5, 0.1 or less. Alternative embodiments include aquaculture meat products further comprising tocochromanol including at least about 100 ppm tocochromanol and aquaculture meat products wherein tocochromanol is a tocopherol.

Preferred embodiments include aquaculture meat products wherein the aquaculture animal is a fish. Alternative embodiments include aquaculture meat products wherein the fish is a coldwater specie of fish, including aquaculture meat products wherein the coldwater fish is selected from the group consisting of Atlantic salmon, Atlantic cod, bigeye tuna, Southern bluefin tuna, Yellowfin tuna, European sea bass, Asian sea bass, Atlantic halibut, Japanese Flounder, North American flounder, Red drum, Cod, Haddock, Turbot, Mackerel, Herring, Sardines, Pilchards, and Trout. Alternative embodiments also include aquaculture meat products wherein the coldwater fish is selected from the group consisting of Atlantic salmon, bluefin tuna, bigeye tuna, yellowfin tuna, Atlantic Halibut, Cobia, Kahala, and Trout. Alternative embodiments also include aquaculture meat products wherein the coldwater fish is selected from the group consisting of Bluefin Tuna, Atlantic Halibut, Cobia, and Trout.

Further alternative embodiments include aquaculture meat products herein the fish is a warm water specie of fish, including aquaculture meat products wherein the warm water fish meat product is selected from the group consisting of carp, catfish, bass, perch, cobia, red drub, sea bream, yellowfin, kahala, yellowtail, milkfish, and tilapia. Alternative embodiments include aquaculture meat products wherein the warm water fish meat product comprises catfish.

Further alternative embodiments include aquaculture meat products herein the aquaculture animal is a crustacean, including meat products wherein the animal is selected from the group consisting of lobsters, crabs, shrimp, prawns, and crayfish. Alternative embodiments also include aquaculture meat products wherein the animal is selected from the group consisting of shrimp and prawns.

Embodiments of the invention also include food products for human consumption comprising the aquaculture meat products made with the aquaculture meat products described.

Embodiments of the invention also include methods of producing a aquaculture product comprising: providing a stearidonic acid source comprising stearidonic acid (SDA), providing additional feed components, contacting the stearidonic acid source with the feed components to make a supplemented feed, feeding the supplemented feed to a plurality of aquaculture animals, and harvesting at least one edible product from the aquaculture animals, wherein the stearidonic acid source comprises a transgenic plant source and wherein at least a portion of the SDA is incorporated into the edible product.

Alternative embodiments of the invention also include methods wherein the stearidonic acid source comprises seeds selected from the group consisting of soybeans, canola, and corn. Alternative embodiments of the invention also include methods wherein the stearidonic acid source comprises oil derived from a portion of a transgenic plant. Alternative embodiments of the invention also include methods wherein the total fatty acids in the supplemented feed comprise at least about 0.1% SDA 0.2% SDA, 0.3% SDA, 0.5% SDA, t 1% SDA, 2% SDA, 10% SDA, 15% SDA, 20% SDA, 25% SDA, or more.

Alternative embodiments of the invention also include methods wherein the aquaculture product is selected from the group consisting of fish meat, shrimp meat, fish oil and fish meal.

Alternative embodiments of the invention also include methods wherein the stearidonic acid source further comprises tocochromanol, including methods wherein the tocochromanol is tocopherol.

Alternative embodiments of the invention also include methods wherein the stearidonic acid source further comprises GLA. Alternative embodiments of the invention also include methods wherein the ratio of concentrations of SDA/GLA is at least about 1.0, 1.3, 1.5, 2.0, 3.0, 4.0, or more. Alternative embodiments of the invention also include methods wherein the omega-3 to omega-6 fatty acid ratio of the stearidonic acid source is greater than about 1:2. Alternative embodiments of the invention also include methods wherein the stearidonic acid source further comprises at least about 0.01% 6-cis, 9-cis, 12-cis, 15-trans-octadecatetraenoic acid. Alternative embodiments of the invention also include methods wherein the stearidonic acid source further comprises at least about 0.01% 9-cis, 12-cis, 15-trans-alpha linolenic acid. Alternative embodiments of the invention also include methods wherein the stearidonic acid source further comprises at least about 0.01% 6,9-octadecadienoic acid.

Alternative embodiments of the invention also include methods wherein the additional feed component comprises ingredients selected from the group consisting of grains (i.e., corn, wheat, barley), oilseed meals (i.e., soybean meal, cottonseed meal, flaxseed meal, canola meal), byproducts (i.e., wheat middlings, wheat bran, rice bran, corn distiller dried grains, brewers grains, corn gluten meal, corn gluten feed, molasses, rice mill byproduct), milk products (i.e., casein, whey proteins,), oils (i.e., corn oil, flax oil, soy oil, palm oil, animal fat, fish oil, restaurant grease, and blends thereof), vitamin and minerals, amino acids, antioxidants, tocochromanols, tocopherols, coccidostats, etc. meat meal, meat and bone meals, fish meal squid meal, blood meal, salt, antibiotics.

Alternative embodiments of the invention also include methods wherein the aquaculture animals are contained in an artificial environment, such as an inland farm.

Preferred embodiments of the invention also include methods wherein the aquaculture animal is a fish. Alternative embodiments of the invention also include methods wherein the fish is selected from the group consisting of cobia, catfish, carp, tilapia, trout, salmon, and trout. Alternative embodiments of the invention also include methods wherein the aquaculture animal is a salmon. Alternative embodiments of the invention also include methods where the feeding occurs on multiple occasions over a period of at least seven days, 21 days, 30 days, 60 days, 90, days, 120 days, 180 days, or more.

Embodiments of the invention also include aquaculture feed comprising stearidonic acid (SDA), gamma linolenic acid (GLA), and additional feed components, wherein the aquaculture feed comprises at least about 0.5% stearidonic acid and at least about 0.1% GLA, wherein the ratio of SDA/GLA is about 1.3.

Alternative embodiments include aquaculture feed wherein the feed further comprises a transgenic plant product selected from the group consisting of transgenic soybeans, transgenic soybean oil, transgenic soy protein, transgenic corn, and transgenic canola.

Alternative embodiments include aquaculture feeds that further comprises alpha-linolenic acid (ALA), including aquaculture feeds wherein the ALA concentration is less than about 40%, less than about 25%, less than about 20%, less than about 15%, or less of the total fatty acid content of the aquaculture feed. Alternative embodiments include aquaculture feed wherein the ratio of SDA/ALA is at least about 0.25, 0.5, 0.75, 1.0, 2.0, or more.

Alternative embodiments include aquaculture feed that further comprises soy protein. Alternative embodiments include aquaculture feed wherein the additional feed components comprise fish oil. Alternative embodiments include aquaculture feed wherein the additional feed components comprise fish meal.

Some embodiments of the invention, the aquaculture feed may have a the stearidonic acid concentration of less than about 35% less than about 25%, less than about 15%, less than about 10%, less than about 5%, less than about 4%, less than about 3%, less than about 2%, less than about 1% or less of the total fatty acids in the feed. Other embodiments include aquaculture feed further comprising at least about 0.01% 6-cis, 9-cis, 12-cis, 15-trans-octadecatetraenoic acid. Alternative embodiments include aquaculture feed comprising at least about 0.01% 9-cis, 12-cis, 15-trans-alpha linolenic acid. Alternative embodiments include aquaculture feed further comprising at least about 0.01% 6,9-octadecadienoic acid. Other embodiments include aquaculture feed further comprising tocochromanol, including feeds comprising at least about 100 ppm tocochromanol and feeds wherein the tocochromanol is tocopherol.

Alternative embodiments include aquaculture feed wherein the feed is a fish feed and wherein the feed is a crustacean feed.

Alternative embodiments include aquaculture feed wherein the additional feed components are selected from the group consisting of grains (i.e., corn, wheat, barley), oilseed meals (i.e., soybean meal, cottonseed meal, flaxseed meal, canola meal), byproducts (i.e., wheat middlings, wheat bran, rice bran, corn distiller dried grains, brewers grains, corn gluten meal, corn gluten feed, molasses, rice mill byproduct), milk products (i.e. casein, whey proteins), oils (i.e. corn oil, flax oil, soy oil, palm oil, animal fat, fish oil, restaurant grease, and blends thereof), vitamin and minerals, amino acids, antioxidants, tocochromanols, tocopherols, coccidostats, etc. meat meal, meat and bone meals, fish meal squid meal, blood meal, salt, and antibiotics.

Embodiments of the invention also include fish derivatives comprising stearidonic acid (SDA), eicosapentaenoic acid (EPA), gamma linolenic acid (GLA) and docosahexaenoic acid (DHA) wherein: the concentration of SDA is at least about 3.0 g/100 g fatty acids, the concentration of the GLA is at least about 1.5 g/100 g fatty acids, the concentration of the EPA is at least about 0.5 g/100 g fatty acids, and the concentration of the DHA is at least about 3.0 g/100 g fatty acids.

Alternative embodiments of the invention also include fish derivatives wherein the fish derivative is a fish oil. Alternative embodiments of the invention also include fish derivatives wherein the fish derivative is a fish meal.

Alternative embodiments of the invention also include fish derivatives wherein the fish derivative is derived from a fish fed feed comprising SDA and GLA and wherein the ration of SDA/GLA in the fish feed is at least about 0.25, 0.5, 1.0, 1.5, 2.0, 2.5, 3.0, or more.

Alternative embodiments of the invention also include fish derivatives wherein the feed further comprises transgenic soybean oil.

Alternative embodiments of the invention also include fish derivatives wherein the SDA concentration is at least about 1.0 g/100 g fatty acids, 2.0 g/100 g fatty acids, 3.0 g/100 g fatty acids, 4.0 g/100 g fatty acids, 5.0 g/100 g fatty acids, 6.0 g/100 g fatty acids, 7.0 g/100 g fatty acids, 10.0 g/100 g fatty acids, 15.0 g/100 g fatty acids or more. Alternative embodiments of the invention also include fish derivatives wherein the GLA concentration is at least about 0.5 g/100 g fatty acids, 1.0 g/100 g fatty acids, 1.5 g/100 g fatty acids, 2.0 g/100 g fatty acids, 2.5 g/100 g fatty acids, 3.0 g/100 g fatty acids, 5.0 g/100 g fatty acids, 1.0 g/100 g fatty acids, or more. Alternative embodiments of the invention also include fish derivatives further comprising DGLA. Alternative embodiments of the invention also include fish derivatives wherein the DGLA concentration is at least about 0.1 g/100 g fatty acids, 0.2 g/100 g fatty acids, 0.3 g/100 g fatty acids, 0.5 g/100 g fatty acids, 1.0 g/100 g fatty acids, 1.5 g/100 g fatty acids, 2.0 g/100 g fatty acids, or more.

Alternative embodiments of the invention also include fish derivatives wherein the ratio of concentrations of GLA/SDA is at least about 0.25, 0.5, 0.8, 1.0, 1.5, 2.0, or more. Alternative embodiments of the invention also include fish derivatives wherein the ratio of concentrations of DGLA/SDA is at least about 0.05, 0.07, 0.1, 0.15, 0.2, 0.3, or more Alternative embodiments of the invention also include fish derivatives wherein the ratio of concentrations of EPA/SDA is at less than about 1, less than about 0.5, less than about 0.1, or less.

Alternative embodiments of the invention also include fish derivatives further comprising tocochromanol, including derivatives wherein the fish derivative comprises at least about 100 ppm tocochromanol, and fish derivatives wherein tocochromanol is a tocopherol.

Embodiments of the invention also include food products for human consumption comprising the fish derivative.

Embodiments of the invention also include supplements for human consumption comprising the fish derivative.

Embodiments of the invention also include fish meat products comprising at least about 3.5 g of stearidonic acid (SDA) per 100 g fatty acid and at least about 0.5 g of DGLA per 100 g fatty acid. Alternative embodiments of the invention also include fish meat products wherein the concentration of SDA is at least about 1.0 g per 100 g fatty acids, 2.0 g per 100 g fatty acids, 3.0 g per 100 g fatty acids, 4.0 g per 100 g fatty acids, 5.0 g per 100 g fatty acids, 6.0 g per 100 g fatty acids, 7.0 g per 100 g fatty acids, 10 g per 100 g fatty acids, 15 g per 100 g fatty acids, or more.

Alternative embodiments of the invention also include fish meat products wherein the concentration of DGLA of at least about 0.25 g per 100 g fatty acids, 0.5 g per 100 g fatty acids, 0.75 g per 100 g fatty acids, 1.0 g per 100 g fatty acids, 1.25 g per 100 g fatty acids, 1.5 g per 100 g fatty acids, 1.75 g per 100 g fatty acids, or more.

Alternative embodiments of the invention also include fish meat products further comprising EPA, DHA, GLA, and ALA. Alternative embodiments of the invention also include fish meat products wherein the EPA comprises at least about 0.15 g/100 g fatty acids, 0.25 g/100 g fatty acids, 0.5 g/100 g fatty acids,0.75 g/100 g fatty acids, 1.0 g/100 g fatty acids, 0.5 g/100 g fatty acids, 0.5 g/100 g fatty acids, or more. Alternative embodiments of the invention also include fish meat products wherein the DHA comprises at least about 0.25 g/100 g fatty acids, 0.5 g/100 g fatty acids, 1.0 g/100 g fatty acids, 2.0 g/100 g fatty acids, 3.0 g/100 g fatty acids, 4.0 g/100 g fatty acids, 5.0 g/100 g fatty acids, 7.0 g/100 g fatty acids, or more. Alternative embodiments of the invention also include fish meat products wherein the ratio of concentrations of EPA/DHA of less than about 0.30, less than about 0.25, less than about 0.20, less than about 0.15, less than about 0.10, less than about 0.05, or less.

The fish meat product wherein the fish meat product is a warm water fish.

Alternative embodiments of the invention also include fish meat products wherein the warm water fish meat product is selected from the group consisting of carp, catfish, bass, perch, cobia, red drub, sea bream, yellowfin, kahala, yellowtail, milkfish, and tilapia.

Alternative embodiments of the invention also include fish meat products wherein the fish meat product is a coldwater fish.

Alternative embodiments of the invention also include fish meat products wherein the coldwater fish is selected from the group consisting of Atlantic salmon, Atlantic cod, bigeye tuna, Southern bluefin tuna, Yellowfin tuna, European sea bass, Asian sea bass, Atlantic halibut, Japanese Flounder, North American flounder, Red drum, Cod, Haddock, Turbot, Mackerel, Herring, Sardines, Pilchards, and Trout.

Embodiments of the invention also include aquaculture feed comprising a fish derivative, and stearidonic acid (SDA), wherein the aquaculture feed comprises at least about 0.5% SDA and at least about 0.3% GLA, wherein the ratio of SDA/GLA is about 1.3. to 4.0 and wherein the SDA is derived from a transgenic plant.

Alternative embodiments include aquaculture feed wherein the feed comprises at least about 0.5% SDA, 1% SDA, 1.5% SDA, 2% SDA, 3% SDA, 4% SDA, 5% SDA, 6% SDA, 7% SDA, 10% SDA, 15% SDA, or more. Alternative embodiments include aquaculture feed wherein the ratio of SDA/GLA is at least about 0.5, 1.0, 2.0, 2.5, 3.0, or more. Alternative embodiments include aquaculture feed wherein the feed comprises at least about 0.25% GLA, 0.5% GLA, 1% GLA, 2% GLA, 3% GLA, 4% GLA, or more. Alternative embodiments include aquaculture feed further comprising DGLA including aquaculture feed having a concentration of DGLA of at least about 0.03%, 0.05% 0.07%, 0.1%, 0.15%, 0.2%, or more. Alternative embodiments include aquaculture feed further comprises ALA.including aquaculture feed having a concentration of ALA of at least about 1%, 2%, 3%, 4%, 5%, 10%, 20%, or more.

Alternative embodiments include aquaculture feed wherein the fish derivative is a fish oil or a fish meal.

Alternative embodiments include aquaculture feed wherein the feed comprises less than about 90%, less than about 75%, less than about 50%, less than about 25%, less than about 10%, less than about 5%, or even less of the total omega-3 fatty acid concentration as stearidonic acid.

Embodiments of the invention also include methods of producing an aquaculture product comprising: providing a fish derivative, feeding the fish derivative to a plurality of aquaculture animals, and harvesting at least one aquaculture product from the aquaculture animals, wherein the fish derivative is an oil or meal derived from a fish which is fed feed comprising stearidonic acid from a transgenic plant source.

Alternative embodiments of the invention also include methods wherein the fish derivative is a fish oil or a fish meal. Alternative embodiments of the invention also include methods wherein the aquaculture product is selected from the group consisting of fish meat, fish meal, and fish oil.

Alternative embodiments also include methods wherein the fish derivative comprises SDA, GLA, EPA, DHA, and DGLA. Alternative embodiments of the invention also include methods wherein the concentration of SDA in the fish derivative is at least about 3 g/100 g fatty acids, about 0.5 g/100 g fatty acids, about 1 g/100 g fatty acids, about 2 g/100 g fatty acids, about 3 g/100 g fatty acids, about 5 g/100 g fatty acids, about 10 g/100 g fatty acids, about 10 g/100 g fatty acids, or more. Alternative embodiments of the invention also include methods wherein the concentration of GLA in the fish derivative is at least about 0.1 g/100 g fatty acids, 0.5 g/100 g fatty acids, 1 g/100 g fatty acids, 2 g/100 g fatty acids, 3 g/100 g fatty acids, 5 g/100 g fatty acids, or more.

Alternative embodiments of the invention also include methods wherein the concentration of DGLA in the fish derivative is at least about 0.1 g/100 g fatty acids, 0.2 g/100 g fatty acids, 0.3 g/100 g fatty acids, 0.4 g/100 g fatty acids, 0.5 g/100 g fatty acids, 1.0 g/100 g fatty acids, 2.0 g/100 g fatty acids, or more. Alternative embodiments of the invention also include methods wherein the ratio of concentrations of SDA/GLA is between 1.0 and 4.0.

Alternative embodiments of the invention also include methods comprising blending the fish derivative with a source of SDA. Alternative embodiments of the invention also include methods wherein the source of SDA is a transgenic plant source.

Embodiments of the invention also include methods of raising a fish comprising: providing a feed comprising a fish derivative, feeding the fish derivative to a plurality of fish, and wherein the fish derivative comprises SDA, GLA, and DGLA and wherein the concentration of GLA is at least about 0.5 g/100 g fatty acids, the concentration of SDA is at least about 3.0 g/100 g fatty acid, and the concentration of DGLA is at least about 0.3 g/100 g fatty acid.

Alternative embodiments of the invention also include methods wherein the fish derivative is a fish oil or a fish meal.

Alternative embodiments of the invention also include methods wherein the concentration of SDA in the fish derivative is at least about 1 g/100 g fatty acids, 2 g/100 g fatty acids, 3 g/100 g fatty acids, 4 g/100 g fatty acids, 5 g/100 g fatty acids, 10 g/100 g fatty acids, 15 g/100 g fatty acids or more. Alternative embodiments of the invention also include methods wherein the concentration of GLA in the fish derivative is at least about 0.5 g/100 g fatty acids, 1 g/100 g fatty acids, 2 g/100 g fatty acids, 3 g/100 g fatty acids, 5 g/100 g fatty acids, 10 g/100 g fatty acids or more. Alternative embodiments of the invention also include methods wherein the concentration of DGLA in the fish derivative is at least about 0.1 g/100 g fatty acids, 0.3 g/100 g fatty acids, 0.5 g/100 g fatty acids, 0.75 g/100 g fatty acids, 1.0 g/100 g fatty acids, 2.0 g/100 g fatty acids, or more. Alternative embodiments of the invention also include methods wherein the ratio of concentrations of SDA/GLA is between 1.0 and 4.0.

Alternative embodiments of the invention also include methods further comprises contacting the fish derivative with a source of stearidonic acid. Alternative embodiments of the invention also include methods wherein the source of stearidonic acid is a transgenic plant source. Alternative embodiments of the invention also include methods wherein the fish derivative is derived from a fish fed stearidonic acid from a transgenic plant source.

Embodiments of the invention also include methods of producing a fish comprising: providing a feed comprising a fish derivative, feeding the fish derivative to a plurality of fish, and wherein the fish derivative comprises SDA, GLA, and linoleic acid (LA) and wherein the ratio of concentrations of GLA/LA is at least about 0.05.

Alternative embodiments of the invention also include methods wherein the fish derivative is a fish oil or a fish meal.

Alternative embodiments of the invention also include methods wherein the concentration of SDA in the fish derivative is at least about 0.5 g/100 g fatty acids, 0.75 g/100 g fatty acids, 1 g/100 g fatty acids, 2 g/100 g fatty acids, 3 g/100 g fatty acids, 5 g/100 g fatty acids, 10 g/100 g fatty acids, 15 g/100 g fatty acids, or more. Alternative embodiments also include methods wherein the concentration of GLA in the fish derivative is at least about 0.5 g/100 g fatty acids, 1 g/100 g fatty acids, 2 g/100 g fatty acids, 3 g/100 g fatty acids, 5 g/100 g fatty acids, or more. Alternative embodiments of the invention also include methods wherein the ratio of concentrations of GLA/LA in the fish derivative is at least about 0.05, 0.1, 0.15, 0.2, 0.25, 0.3, 0.5, 1.0, 1.5, 2.0, or more. Alternative embodiments of the invention also include methods wherein the ratio of concentrations of SDA/GLA is between 1.0 and 4.0.

Alternative embodiments of the invention also include methods further comprises contacting the fish derivative with a source of SDA. Alternative embodiments of the invention also include methods wherein the source of SDA is a transgenic plant source. Alternative embodiments of the invention also include methods wherein the fish derivative is derived from a fish fed SDA from a transgenic plant source.

Embodiments of the invention also include fish derivatives comprising stearidonic acid (SDA), eicosapentaenoic acid (EPA), gamma linolenic acid (GLA), dihomo-gamma-linolenic acid (DGLA), linoleic acid (LA) and docosahexaenoic acid (DHA) wherein: the ratio of concentrations of GLA/LA is at least about 0.1; and the concentration of DGLA is at least about 0.5 g/100 g fatty acids.

Other embodiments of the invention also include fish derivatives wherein the ratio of concentrations of GLA/LA is at least about 0.10, 0.15, 0.20, 0.25, 0.30, 0.50 or more. Alternative embodiments of the invention also include fish derivatives wherein the concentration of DGLA is at least about 0.25 g/100 g fatty acids, 0.5 g/100 g fatty acids, 0.75 g/100 g fatty acids, 1.0 g/100 g fatty acids, 2.0 g/100 g fatty acids, or more. Alternative embodiments of the invention also include fish derivatives having a concentration of SDA of at least about 1.0 g/100 g fatty acids, 2.0 g/100 g fatty acids, 3.0 g/100 g fatty acids, 4.0 g/100 g fatty acids, 5 g/100 g fatty acids, 10 g/100 g fatty acids, 15 g/100 g fatty acids, 20 g/100 g fatty acids, or more. Other embodiments of the invention also include fish derivatives having a concentration of GLA of at least about 0.5 g/100 fatty acids, 1.0 g/100 fatty acids, 2.0 g/100 fatty acids, 3.0 g/100 fatty acids, 5 g/100 fatty acids, 10 g/100 fatty acids, or more. Alternative embodiments of the invention also include fish derivatives having a ratio of concentrations of SDA/GLA of between about 1.3 and 4.0.

Alternative embodiments of the invention also include fish derivatives wherein the fish derivative is fish oil or fish meal.

Embodiments of the invention also include products for human consumption comprising the fish derivative described above.

Embodiments of the invention also include edible products wherein the edible product is a dietary supplement comprising the fish derivative described above.

Embodiments of the invention also include methods of producing a crustacean comprising: providing a feed comprising stearidonic acid (SDA) source, feeding the feed to a plurality of crustacean, wherein the SDA source comprises SDA and GLA, and wherein the SDA source comprises a transgenic vegetable oil.

Alternative embodiments of the invention also include methods wherein the transgenic vegetable oil is a transgenic soybean oil. Alternative embodiments of the invention also include methods wherein said SDA source has a ratio of concentrations of SDA/GLA of about 1.3 to 4.0.

Alternative embodiments of the invention also include methods wherein the feed further comprises a fish derivative, including methods wherein the fish derivative is a fish meal and methods wherein the fish derivative is a fish oil.

Alternative embodiments of the invention also include methods wherein the fish derivative supplies less than about 90%, less than about 75%, less than about 50%, less than about 25%, less than about 15%, less than about 10%, less than about 5%, or even less of the total fatty acid content of the feed. Alternative embodiments of the invention also include methods wherein the feed comprises at least about 0.2 g SDA per 100 g total fatty acids, 0.5 g SDA per 100 g total fatty acids, 1.0 g SDA per 100 g total fatty acids, 2.0 g SDA per 100 g total fatty acids, 3.0 g SDA per 100 g total fatty acids, 5 g SDA per 100 g total fatty acids, 7 g SDA per 100 g total fatty acids, 10 g SDA per 100 g total fatty acids, 12 g SDA per 100 g total fatty acids, 15 g SDA per 100 g total fatty acids, 20 g SDA per 100 g total fatty acids, 25 g SDA per 100 g total fatty acids or more. Alternative embodiments of the invention also include methods wherein the feed comprises at least about 0.5 g GLA per 100 g total fatty acids, 1.0 g GLA per 100 g total fatty acids,2.0 g GLA per 100 g total fatty acids, 3.0 g GLA per 100 g total fatty acids, 5 g GLA per 100 g total fatty acids, 10 g GLA per 100 g total fatty acids, 15 g GLA per 100 g total fatty acids or more.

Alternative embodiments of the invention also include methods wherein the fish derivative is derived from a fish fed stearidonic acid.

Alternative embodiments of the invention also include methods wherein the crustacean is selected from the group consisting of lobster, crab, shrimp, prawn or crayfish. Alternative embodiments of the invention also include methods wherein the crustacean is a shrimp or prawn.

Embodiments of the invention also include food products for human consumption comprising a crustacean described above.

The present invention relates to a system for an improved method for the plant based production of stearidonic acid and its incorporation into the diets of humans and livestock in an effort to improve human health. This production is made possible through the utilization of transgenic plants engineered to produce SDA in sufficiently high yield to so as to allow commercial incorporation into food products. For the purposes of the current invention the acid and salt forms of fatty acids, for instance, butyric acid and butyrate, arachidonic acid and arachidonate, will be considered interchangeable chemical forms.

All higher plants have the ability to synthesize the main 18 carbon PUFA's, LA and ALA, and in some cases SDA (C18:4n3, SDA), but few are able to further elongate and desaturate these to produce arachidonic acid (AA), EPA or DHA. Synthesis of EPA and/or DHA in higher plants therefore requires the introduction of several genes encoding all of the biosynthetic enzymes required to convert LA into AA, or ALA into EPA and DHA. Taking into account the importance of PUFAs in human health, the successful production of PUFAs (especially the n-3 class) in transgenic oilseeds, according to the current invention can then provide a sustainable source of these essential fatty acids for dietary use. The “conventional” aerobic pathway which operates in most PUFA-synthesizing eukaryotic organisms, starts with Δ6 desaturation of both LA and ALA to yield γ-linolenic (GLA, 18:3n6) and SDA.

Turning to Table 1, it is important to provide a basis of what constitutes “normal” ranges of oil composition vis-à-vis the oil compositions of the current invention. Table 1 gives examples of fatty acid content of various oils commonly used in food products, expressed as a percentage of total oil.

TABLE 1
Standards for fatty acid composition of oils (% of Oil)

| | Rapeseed | | | | | | | |
|---|---|---|---|---|---|---|---|---|
| | oil (low | | | | | | | |
| Fatty | erucic | Sesame | Soybean | Sunflower | | | | |
| acid | acid) | seed oil | oil | seed oil | Arachis oil (peanut oil) | Coconut oil | Maize oil | Palm oil |
| C6:0 | ND | ND | ND | ND | ND | ND-0.7 | ND | ND |
| C8:0 | ND | ND | ND | ND | ND | 4.6-10.0 | ND | ND |
| C10:0 | ND | ND | ND | ND | ND | 5.0-8.0 | ND | ND |
| C12:0 | ND | ND | ND-0.1 | ND-0.1 | ND-0.1 | 45.1 53.2 | ND-0.3 | ND-0.5 |
| C14:0 | ND-0.2 | ND-0.1 | ND-0.2 | ND-0.2 | ND-0.1 | 16.8-21.0 | ND-0.3 | 0.5-2.0 |
| C16:0 | 2.5-7.0 | 7.9-12.0 | 8.0-13.5 | 5.0-7.6 | 8.0-14.0 | 7.5-10.2 | 8.6-16.5 | 39.3-47.5 |
| C16:1 | ND-0.6 | ND-0.2 | ND-0.2 | ND-0.3 | ND-0.2 | ND | ND-0.5 | ND-0.6 |
| C17:0 | ND-0.3 | ND-0.2 | ND-0.1 | ND-0.2 | ND-0.1 | ND | ND-0.1 | ND-0.2 |
| C17:1 | ND-0.3 | ND-0.1 | ND-0.1 | ND-0.1 | ND-0.1 | ND | ND-0.1 | ND |
| C18:0 | 0.8-3.0 | 4.5-6.7 | 2.0-5.4 | 2.7-6.5 | 1.0-4.5 | 2.0-4.0 | ND-3.3 | 3.5-6.0 |
| C18:1 | 51.0-70.0 | 34.4-45.5 | 17-30 | 14.0-39.4 | 35.0-69 | 5.0-10.0 | 20.0-42.2 | 36.0-44.0 |
| C18:2 | 15.0-30.0 | 36.9-47.9 | 48.0-59.0 | 48.3-74.0 | 12.0-43.0 | 1.0-2.5 | 34.0-65.6 | 9.0-12.0 |
| C18:3 | 5.0-14.0 | 0.2-1.0 | 4.5-11.0 | ND-0.3 | ND-0.3 | ND-0.2 | ND-2.0 | ND-0.5 |
| C20:0 | 0.2-1.2 | 0.3-0.7 | 0.1-0.6 | 0.1-0.5 | 1.0-2.0 | ND-0.2 | 0.3-1.0 | ND-1.0 |
| C20:1 | 0.1-4.3 | ND-0.3 | ND-0.5 | ND-0.3 | 0.7-1.7 | ND-0.2 | 0.2-0.6 | ND-0.4 |
| C20:2 | ND-0.1 | ND | ND-0.1 | ND | ND | ND | ND-0.1 | ND |
| C22:0 | ND-0.6 | ND-1.1 | ND-0.7 | 0.3-1.5 | 1.5-4.5 | ND | ND-0.5 | ND-0.2 |
| C22:1 | ND-2.0 | ND | ND-0.3 | ND-0.3 | ND-0.3 | ND | ND-0.3 | ND |
| C22:2 | ND-0.1 | ND | ND | ND-0.3 | ND | ND | ND | ND |
| C24:0 | ND-0.3 | ND-0.3 | ND-0.5 | ND-0.5 | 0.5-2.5 | ND | ND-0.5 | ND |
| C24:1 | ND-0.4 | ND | ND | ND | ND-0.3 | ND | ND | ND |

Source: CODEX STANDARD FOR NAMED VEGETABLE OILS, CODEX-STAN 210 (Amended 2003, 2005).
ND is non-detectable, defined as ≦0.05%.

More recently, oils from transgenic plants have been created. Some embodiments of the present invention may incorporate products of transgenic plants such as transgenic soybean oil. Transgenic plants and methods for creating such transgenic plants can be found in the literature. See for example, WO2005/021761A1, herein incorporated by reference. As shown in Table 2, the composition of the transgenic soy oil is substantially different than that of the accepted standards for soy oil.

TABLE 2
A comparison of transgenic soy oil and traditional soy
oil fatty acid compositions (% of Oil)

| | High | Medium | Low |
|---|---|---|---|
| | SDA | SDA Soy | SDA |
| | Soy Oil | Oil | Soy Oil |
| C14:0 (Myristic) | 0.1 | 0.1 | 0.1 |
| C16:0 (Palmitic)) | 12.5 | 12.3 | 12.1 |
| C16:1 (Palmitoleic) | 0.1 | 0.1 | 0.1 |
| C18:0 (Stearic) | 4.2 | 4.6 | 4.2 |
| C18:1 (Oleic) | 16.0 | 18.7 | 19.4 |
| C18:2 (Linoleic) | 18.5 | 23.9 | 35.3 |
| C18:3 n6 (Gamma Linolenic) | 7.2 | 6.4 | 4.9 |
| C18:3 n3 (Alpha-Linolenic) | 10.3 | 10.8 | 10.1 |
| C18:4 n3 (Stearidonic) | 28.0 | 20.5 | 11.4 |
| C20:0 (Arachidic) | 0.4 | 0.4 | 0.4 |
| C20:1 (Eicosenoic) | 0.3 | 0.2 | 0.4 |
| C22:0 (Behenic) | 0.3 | 0.3 | 0.4 |
| C24:0 (Lignoceric) | 0.1 | 0.1 | 0.1 |
| 6-cis,9-cis,12-cis,15-trans- | <0.2% | <0.2% | <0.2% |
| octadecatetraenoic acid | | | |
| 9-cis,12-cis,15-trans-alpha linolenic acid | <0.2% | <0.2% | <0.2% |
| 6,9-octadecadienoic acid | <0.2% | <0.2% | <0.2% |
| Total trans-fatty acid | 1.5 | 1.2 | 0.9 |
| Other fatty acids | 0.6 | 0.6 | 0.3 |

Given the above and according to the current invention, the SDA rich soybeans produced in a recombinant oilseed plant provides a composition not previously available for feed manufacturers. It provides for the incorporation of seeds into aquaculture feed with a unique fatty acid profile that was not present in appreciable amounts in typical feeds prior to the current invention. In addition the use of this feed is made possible without the traditional concerns with stability when oils comprising DHA are delivered from a fish or algal source. The feed incorporating such transgenic plant seeds can be further utilized for the production of food products including aquaculture products having enhanced nutritional content.

For the instant invention the preferred source of stearidonic acid is transgenic soybeans which have been engineered to produce high levels of stearidonic acid. The soybeans may be processed at an oil processing facility and oil may be extracted consistent with the methods described in US Patent Applications 2006/0111578A1, 2006/0110521A1, and 2006/0111254A1.

### Methods of Feeding Aquaculture:

Acordingly, in embodiments of the present invention, the methods comprise increasing the levels of Omega-3 fatty acids where stearidonic acid is added to said aquaculture livestock in an amount in excess of 0.2%, 0.4%, 0.6%, 0.8%, 1.0%, 2.0%, 3.0%, or 4.0% of the feed. In some embodiments, the concentration of SDA may be added to the livestock feed in amounts as high as 5 % or even 10%. The source of added stearidonic acid can be synthetic or natural. The natural stearidonic acid is sourced from a grain or marine oils or from oils from the group consisting of palm oil, sunflower oil, safflower oil, cottonseed oil, canola oil, corn oil, soybean oil, and flax oil. The natural stearidonic acid in the grain or oilseed is genetically modified to an elevated level in such grain or oil as compared to the levels of stearidonic acid found in the native grain or oil.

The SDA may be incorporated in the diet in the form of a whole seed, ground seed, extruded seed, extracted oil, triglyceride, or ethyl ester. The form of SDA may be incorporated into the diet and fed as a meal, crumble, pellet, sprayed on a pellet, or vacuum coated in the pellet. The SDA may be combined with grains (i.e., corn, wheat, barley), oilseed meals (i.e., soybean meal, cottonseed meal, flaxseed meal, canola meal), byproducts (i.e., wheat middlings, wheat bran, rice bran, corn distiller dried grains, brewers grains, corn gluten meal, corn gluten feed, molasses, rice mill byproduct), milk products (i.e., casein, whey proteins, ), oils (i.e., corn oil, flax oil, soy oil, palm oil, animal fat, fish oil, restaurant grease, and blends thereof), vitamin and minerals, amino acids, antioxidants, tocochromanols, tocopherols, coccidostats, meat meal, meat and bone meals, fish meal, squid meal, blood meal, etc.

For example, most diets for Atlantic salmon are produced by extrusion to help enable the pellets to float. A range of compositions for practical salmonid diets is presented in Table 3. At the end of the 1990s soybean oil or canola oil were substituted for part of the fish oil because of limited availability f the fish oil (Storebakken, 2002).

TABLE 3
Typical ranges for formulation and chemical composition of diets
for different size classes of Atlantic salmon (Storebakken, 2002)

| | | | | | | Brood |
|---|---|---|---|---|---|---|
| | Starter | Fingerling | Smolt | Grower | Finisher | Stock |
| Ingredient (%) | | | | | | |
| Fish-meal | 35-60 | 35-60 | 35-60 | 25-50 | 25-50 | 25-50 |
| Soy products | 0 | 0-5 | 0-5 | 0-15 | 0-15 | 0-15 |
| Gluten | 0-15 | 0-15 | 0-15 | 5-20 | 5-20 | 5-20 |
| products | | | | | | |
| Cereal grains | 8-15 | 8-15 | 8-15 | 10-18 | 10-18 | 10-18 |
| Oils | 10-15 | 10-20 | 10-20 | 20-30 | 10-30 | 10-30 |
| Others* | 3-5 | 3-5 | 3-5 | 3-5 | 3-5 | 3-5 |
| Composition of | | | | | | |
| DM (%) | | | | | | |
| Crude protein | 50-60 | 50-60 | 50-55 | 35-55 | 35-55 | 50-60 |
| Crude fat | 18-25 | 18-30 | 18-30 | 30-40 | 20-40 | 20-35 |
| Starch | 6-12 | 6-12 | 6-12 | 7-15 | 7-15 | 7-15 |

DM, dry matter.
*Vitamin and micromineral premixes, macronutrients, pellet binders, carotenoids, and other additives.

Rainbow trout have been farmed for hundreds of years and are the most widely grown trout in the world. Diet formulations for rainbow trout grown in marine cages differ from those for trout grown in freshwater cages Table 4. Feed is fed as small particles when the fish are very young and the particle size uncreases up to 8 mm pellets as the fish get larger (Hardy, 2002).

TABLE 4
Generalized practical feed formulations used for rainbow trout
reared in sea water and fresh water (Hardy, 2002).

| | | Freshwater diet |
|---|---|---|
| | Sea-water diet (g kg⁻¹) | (g kg⁻¹) |
| Ingredient | | |
| Fish meal | 550 | 400 |
| Poultry by-product meal | | 80 |
| Blood meal | | 0-50 |
| Soybean meal | 50 | 50-100 |
| Wheat grain and by-products | 144 | 120-250 |
| Vitamin premix | 10 | 10 |
| Trace mineral premix | 1 | 1 |
| Choline chloride (60%) | 4 | 4 |
| Ascorbic acid | 1 | 1 |
| Fish oil | 240 | 120-210 |
| Carophyll Pink ® | 0.1 | — |
| Proximate composition | | |
| Moisture | 8% | 8% |
| Crude protein | 43% | 45% |
| Crude fat | 28% | 18-26% |

Farm raised channel catfish is the main aquaculture enterprise in the United States. Catfish are fed pelleted feed of different sizes dependent on fish size. Examples of Channel catfish diets (dry diet, crumble/pellet) are provided in Table 5.

TABLE 5
Practical complete diets for Channel catfish (Tacon, 1988)

| | Starter | | Fingerling | | | | |
|---|---|---|---|---|---|---|---|
| | diets | | diets | | Grower diets | | |
| Ingredient (%) | 1 | 2 | 3 | 4 | 5 | 6 | 7 |
| Fish meal | 84.5 | 45.9 | 27.9 | 10 | 12 | 8 | — |
| Poultry by-product meal | — | 38 | — | — | — | — | — |
| Meat and bone meal | — | — | — | — | — | — | 15 |
| Rice Bran or wheat shorts | — | — | — | — | — | 10 | — |
| Soybean meal | — | — | 15.5 | 37 | 25 | 48.25 | 47.5 |
| Brewers yeast, dried | — | 10 | 30.8 | — | — | — | — |
| Wheat grain, ground | 13 | 15.5 | 4.1 | — | 4 | — | — |
| Cottonseed meal | — | — | 24.8 | — | — | — | — |
| Corn grain, ground | — | — | — | 23.5 | 33.2 | 29.1 | 33 |
| Groundnut meal | — | — | — | 18 | 25 | — | — |
| Distillers dried solubles | — | — | — | 7.5 | — | — | — |
| Wheat middlings | — | — | — | — | — | — | 1.75 |
| Whey, dried | — | — | — | — | — | — | 2.4 |
| Tallow | 3.1 | 2 | — | — | — | — | — |
| Fish oil, menhaden | — | — | 3 | — | — | — | — |
| Micronutrient premix | 2.5 | 2.5 | 2.5 | — | — | — | — |
| Dicalcium phosphate | — | — | — | 1.5 | 0.7 | 1 | 0.25 |
| Vitamin premix | — | — | — | 0.05 | 0.05 | 0.05 | 0.05 |
| Lignosulphonate (binder) | — | — | — | 2.5 | — | 2 | — |
| Binder (Na CMC) | 2.5 | 2.5 | 2 | — | — | — | — |
| Trace mineral premix | — | — | — | 0.075 | 0.05 | 0.5 | 0.5 |
| Propionic acid (fungicide) | 0.5 | 0.5 | 0.5 | — | — | — | — |
| Coated ascorbic acid (98%) | — | — | — | 0.05 | — | 0.0375 | 0.0375 |
| Fat (sprayed on finished feed) | — | — | — | — | — | 1.5 | — |
| Nutrient content, % dry | | | | | | | |
| matter | | | | | | | |
| Crude protein | 58.5 | 55.5 | 44.3 | 36 | 35 | 32 | 32 |
| Lipid | 11.5 | 10.6 | 6.4 | NA | NA | NA | NA |

There are many different varieties of shrimp that are farmed. Tacon (1988) has provided examples of practical complete diets for carnivorous/omnivorous shrimp and prawns. The diets vary whether they are for Kuruma shrimp, giant tiger shrimp, giant river prawn, and other species.

Addition of oil to the diet provides a source of energy and highly unsaturated fatty acids that may be required for growth and reproduction. A limited amount of oil may be added to the ingredient mixture prior to pelleting. Too much oil will negatively affect the pellet durability or binding quality. In cases where more oil is needed, upwards to 2% or less can be sprayed onto the outside of the pellet or extruded material or upwards to 40% can be vacuum coated onto the pellet especially in the case of salmon feeds. Pelleting, through compression, produces a dense pellet that sinks rapidly in water. Extrusion is a process through which the feed material is moistened, precooked, expanded, extruded and dried producing a low-density feed particle which floats in water. Depending on the aquatic species either a pellet or extruded feed is used.

Embodiments of the present invention may incorporate any methods known in the art for feeding aquaculture animals, aquaculture farming techniques, and/or aquaculture product processing techniques. Examples of techniques which may be useful in embodiments of the present invention include the following, herein incorporated by reference: U.S. Pat. No. 3,406,662, U.S. Pat. No. 3,473,509, U.S. Pat. No. 3,601,094, U.S. Pat. No. 3,777,709, U.S. Pat. No. 3,998,186, U.S. Pat. No. 4,137,868, U.S. Pat. No. 4,399,769, U.S. Pat. No. 4,509,458, U.S. Pat. No. 4,640,227, U.S. Pat. No. 4,931,291, U.S. Pat. No. 5,030,657, U.S. Pat. No. 5,032,410, U.S. Pat. No. 5,102,671, U.S. Pat. No. 5,128,153, U.S. Pat. No. 5,158,788, U.S. Pat. No. 5,215,767, U.S. Pat. No. 5,573,792, U.S. Pat. No. 5,698,246, U.S. Pat. No. 5,936,069, U.S. Pat. No. 6,016,770, U.S. Pat. No. 6,463,882, U.S. Pat. No. 6,623,776, U.S. Pat. No. 6,685,980, U.S. Pat. No. 6,789,502, U.S. Pat. No. 6,851,387, U.S. Pat. No. 6,854,422, U.S. Pat. No. 7,055,461, U.S. Pat. No. 7,063,855, U.S. Pat. No. 7,069,876, U.S. Pat. No. 7,101,988, U.S. Pat. No. 7,121,227, US2002119237A1, US2003104113A1, US2003124218A1, US2003232039A1, US2003232059A1, US2003235565A1, US2005215623A1, US2006128665A1, US2006240165A1, US200701 19380A1.

Some embodiments of particular interest include methods of inland aquaculture farming. For example, catfish, trout, tilapia, salmon, kahala, striped bass, cobia, and shrimp are farmed in artificial environments. In such environments, the primary food source is supplied to the fish or shrimp with a significant amount of control. As such, incorporation of beneficial fatty acids in the feed can be especially effective.

In some embodiments, saltwater and anadromous fish may even be grown for significant periods in freshwater. See, for example, U.S. Pat. Nos. 6,463,882, 6,854,422, 7,182,041, 6,951,739, 6,979,558, 6,979,559, 7,055,461, 7,069,876, and 7,101,988, herein incorporated by reference. In such cases, the ability to supply the appropriate fatty acids is extremely important and is believed to be a significant opportunity for combinations with land-based omega-3 sources such as stearidonic acid, particularly stearidonic acid derived from transgenic soybeans.

In some embodiments, feed comprising SDA is combined with fish oil or fish meal in the aquaculture animal diet. Furthermore, it may be desirable to minimize the alteration of the fish diet when shifting from a marine-based omega three source to a land-based omega-3 source by using combinations of SDA-supplemented feed with traditional feed sources containing fish oil and/or fish meal. While embodiments of the current invention include aquaculture feeds and methods of feeding wherein SDA is used as the primary source of omega-3 fatty acids, alternative embodiments may include methods wherein SDA is used in combination with other sources of EPA and DHA, such as fish oil and fish meal.

In some embodiments, the amount of SDA in the feed may be altered as the fish matures. In preferrable embodiments, the amount of SDA in the diet increases over time, either gradually, or in distinct phases. In some species of fish, such as trout and salmon, where there may be specific EPA/DHA requirements in the young fish, the proportion of fish oil:SDA may be as high as 100:0. As the fish grows, the requirement for EPA/DHA declines to the point where all PUFA requirements can be met by the levels provided in the fish meal component of the diet. During the later development of the fish, the proportions of fish oil: SDA may be decreased to 0:100 without negatively affecting health or growth of the fish.

In order to attain the desired concentration of SDA and other fatty acids in the fish tissue, different combinations of dietary concentrations of SDA in the diet and duration of feeding the SDA may be employed. Also, vegetable oil containing SDA may be used as an extender of fish oil to obtain the similar levels of omega 3's in the fish with no negative effects on health of performance. In some embodiments, fish oil is blended with vegetable oil comprising SDA to make a blended oil. The SDA content of the SDA/fish oil blend may be in excess of 0.1%, 0.2%, 0.4%, 0.6%, 0.8%, 1.0%, 2.0%, 3.0%, or 4.0% of the feed. In some embodiments, the concentration of SDA in the blended oil may be as high as 5%, 10%, 15%, 20%, 25%, or even 30%. In some embodiments of the invention, the fish may be fed for periods of as little as 1 day. In preferred embodiments, fish are fed on multiple occasions over multiple days. In preferred embodiments, aquaculture animals are fed feed containing SDA from a vegetable based source over a period of at least about 7 days, 21 days, 30 days, 60 days, 90 days, 120 days, 150 days or even 180 days or more.

Further embodiments of the invention also include fish oil and fish meal derived from fish fed diets supplemented with SDA. Fish oil and meal derived from such fish has unique fatty acid profiles in comparison with fish not fed SDA, as described below in the examples. In particular, fish derivatives from fish fed SDA have elevated levels of SDA, increased ratios of concentrations of SDA/EPA, SDA/ALA, and/or SDA/DHA. Furthermore, for fish fed feeds comprising SDA and GLA, the fish derivatives have elevated levels of GLA, and increased GLA/EPA, GLA/ALA, and/or GLA/DHA ratios; in preferred embodiments, fish derivatives from fish fed feed comprising SDA and GLA also have elevated levels of DGLA.

Further embodiments of the invention also include supplementing the diet of an aquaculture organism with fish derivatives such as fish oil and/or fish meal, which are derived from fish fed feed comprising SDA. The proportion of each of the various fatty acids differs when the fish are fed diets comprising stearidonic acid. In for example, increased levels of SDA, GLA, and DGLA are observed. Furthermore, increased ratios of concentration such as for example GLA/LA are also observed.

These unique compositions and fatty acid ratios are expected to provide unique fish derivative compositions such as fish oils and fish meals which also have unique characteristics. Benefits of feeding these unique meals and oils are expected to propagate through the feeding cycle through multiple generations as SDA-comprising feed is fed to a first generation of fish, then fish derivatives are fed to a second generation of fish, and a second generation of fish derivatives are fed to a third generation of fish, and so on.

Further embodiments of the invention include supplements and therapeutics derived from fish tissues such as fish oil or fish meal comprising SDA, in particular, supplements and therapeutics for human consumption. In some cases, these supplements and therapeutics may have elevated levels of SDA, GLA, and DGLA in comparison with traditional fish oil processed in a similar manner. SDA, GLA, and DGLA are known to have health benefits, such as for example anti-inflammatory effects.

These derivatives will comprise fatty acids with a unique compositions, as mentioned above. However, methods of extracting and purifying fish oil and preparing edible compostions for use as a supplement can be applied from existing methods well known in the art. Examples of related processes and methods can be found in the following US patents and applications: U.S. Pat. No. 4,874,629, U.S. Pat. No. 5,130,061, U.S. Pat. No. 5,149,851, U.S. Pat. No. 5,374,657, U.S. Pat. No. 5,565,214, U.S. Pat. No. 5,693,835, U.S. Pat. No. 5,840,945, U.S. Pat. No. 5,855,944, U.S. Pat. No. 5,955,102, U.S. Pat. No. 6,200,601, U.S. Pat. No. 6,596,766, U.S. Pat. No. 7,001,610, U.S. Pat. No. 7,179,491, US 2003077342A1, US2003087879A1, US2003165596A1, US2003198730A1, US2004001874A1, US2004009208A1, US2004059142A1, US2004076695A1, US2004208939A1, US2005032757A1, US2005249821A1, US2005271791A1, US2006068019A1, US2006088574A1, US2006166935A1, US2006217356A1, US2006228403A1, US2007184090A1.

### Improved Aquaculture Productivity

In food production, and specifically producing aquaculture animal products such as fish meat, shrimp, crab, lobster, etc., there is need to improve production efficiency. Production efficiency, that is the production of the maximum quantity of aquaculture animal products while minimizing the time and cost of production for those products, is important in maintaining a competitive economic advantage. In such an industry, a livestock producer generally wants to maximize the amount of aquaculture animal product produced (e.g. fish meat, shrimp meat) while keeping the costs associated with feed as low as possible in order to achieve maximum aquaculture animal productivity. The maximized amount of aquaculture animal product should be produced at a minimized cost to the producer. Costs to the producer include the cost of feed needed to produce the aquaculture animal products, as well as the costs of related equipment and housing facilities for the aquaculture animals. Importantly, to maximize productivity gains relative to costs such gains should preferably be produced in a minimum time period.

Alternative embodiments of the present invention provides a method for improving aquaculture animal productivity for those species requiring a source of omega 3 fatty acids by providing lower cost plant-based omega-3 fatty acids such that it can become a regular part of the diet and will in turn enhance aquaculture animal reproductive capacity, weight gain and/or overall productivity. (Calder (2002); Klasing (2000); and, Mattos (2000)).

### Illustrative Embodiments of the Invention

The following examples are included to demonstrate general embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the invention.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied without departing from the concept and scope of the invention.

In the examples below, soybean oil containing SDA derived from genetically modified soybeans were used in place of traditional oils. Similar results would be obtained when feeding oil derived from transgenic plants such as corn, or canola.

### EXAMPLE 1

### Warmwater Aquaculture Products <<Catfish>>

The objective of this study is to evaluate effects of dietary stearidonic acid (SDA) derived from SDA-enhanced, genetically modified soybeans and dietary alpha linolenic acid (ALA) in flaxseed (linseed) oil on the fatty acid composition and sensory quality of channel catfish. This was assessed by comparing the fatty acid composition and sensory quality of channel catfish fed diets containing SDA-enriched soybean oil, flaxseed oil and conventional soybean oil.

The test substance was soybean oil derived from soybeans containing SDA (labeled as Oil-1). The control substances were soybean oil derived from a genetically similar soybean that did not contain SDA (labeled as Oil-2) and conventional source of flaxseed oil (labeled as Oil-3). The test and control oils were stored at ˜−20 C prior to diet preparation. The oils were analyzed for fatty acid content (see table below).

TABLE 6
Fatty acid composition of SDA soy oil (Oil-1), conventional
soy oil (Oil-2), and flaxseed oil (Oil-3).

| Fatty Acid | Oil-1 | Oil-2 | Oil-3 |
|---|---|---|---|
| C12:0, % | Trace | 0.2 | — |
| C14:0, % | Trace | 0.1 | — |
| C16:0, % | 14.2 | 11.8 | 6.0 |
| C18:0, % | 4.8 | 3.7 | 4.1 |
| C18:1 n-9, % | 18.2 | 18.6 | 18.5 |
| C18:1 n-7, % | 2.1 | 1.6 | 0.7 |
| C18:2 n-6, % | 30.7 | 55.3 | 15.4 |
| C18:3 n-3, % | 12.0 | 8.6 | 55.2 |
| C18:4 n-3, % | 18.1 | — | — |
| C20:0, % | — | 0 | 0.1 |
| Total ω-6, % | 30.7 | 55.3 | 15.4 |
| Total ω-3, % | 30.1 | 8.6 | 55.2 |

TestSystem: Forty channel catfish (Ictalurus punctatus) that were approximately 12-16 months of age and weighing approximately 450 grams were housed in forty 30-gallon glass aquaria containing approximately 80 liters of water and connected to a flowing water system. Each aquarium was supplied with local well water at a flow rate of approximately 0.7 to 1 liter per minute and under continuous aeration. Water temperature was maintained at approximately 30±1° C. Dissolved oxygen was at least 5 mg/liter.

Light cycle: Fish were maintained on a 14-hour light/10-hour dark cycle. Medication: Salt (approximately 320 grams) was added to each tank after handling to reduce handling stress.

Experimental Design: Five groups of channel catfish (8 aquaria per group, one fish per aquarium) were fed once daily for 10 weeks with diets containing either 2 or 4% of the test and control oils. Survival, body weight gain, feed conversion, and proximate composition of representative fillets were assessed. Fatty acid composition was measured in the feed, catfish fillets and skins. Sensory evaluation of the fillets were conducted.

TABLE 7
The following groups were included in this study:

| Group | | | |
|---|---|---|---|
| Number | Identity | Description | Dietary Level |
| 1 | Diet 1 | Oil-3 | 4% |
| 2 | Diet 2 | Oil-2 | 2% |
| 3 | Diet 3 | Oil-2 | 4% |
| 4 | Diet 4 | Oil-1 | 2% |
| 5 | Diet 5 | Oil-1 | 4% |

Acclimation: Four weeks prior to study initiation, 80 fish were transferred from holding tanks or ponds into each of 80 aquaria (1 fish per aquarium) located inside of the wet laboratory. During this period, the fish were fed a commercial catfish diet (sinking) once daily at approximately 0.3% of their body weight.

Assignment to Treatment Groups: After acclimation, 40 tanks were selected for experimental feeding. Eight aquaria, each containing one fish, were selected at random for each diet. The remaining fish were returned to the holding tanks or ponds.

Feeding: All fish were fed once daily (0800-0900 hours) to approximate satiation for 10 weeks, except that no feeding took place on days the fish were weighed. The feeding rate (as a percentage of actual or estimated body weight) was adjusted at least weekly based on feed consumption observations during the previous week.

### Catfish Diets

DietPreparation. Five experimental diets were evaluated: 1) 4% conventional flaxseed oil; 2) 2% conventional soybean oil; 3) 4% conventional soybean oil; 4) 2% SDA-enriched soybean oil; and 5) 4% SDA-enriched soybean oil. Initially, one batch (˜8 kg) of each diet was prepared. Additional diets were prepared as needed. Each diet was thoroughly blended together and stored frozen (approximately −20° C.) in sealed plastic bags until fed. Diets were based on typical channel catfish feeds, except that 2% or 4% soybean oils and 4% flaxseed oil were used (see Table 8). The diets were formulated to contain approximately 28% crude protein (isonitrogenous) and met all known catfish nutrient requirements. Flaxseed oil diet was prepared first followed by the control soybean oil diets, and lastly the test diets.

Table 8 Ingredient composition¹ of diets.

TABLE 8
Ingredient composition¹ of experimental catfish diets
(expressed as percentages on an as-fed basis).

| | Diet 1 | Diet 2 | Diet 3 | Diet 4 | Diet 5 |
|---|---|---|---|---|---|
| | (4% | (2% | (4% | (2% | (4% |
| Ingredient | FLO2) | SBO3) | SBO) | SDA4) | SDA) |
| Soybean meal | 39.33 | 38.85 | 39.33 | 38.85 | 39.33 |
| Cottonseed meal | 5.00 | 5.00 | 5.00 | 5.00 | 5.00 |
| Menhaden fish meal | 3.00 | 3.00 | 3.00 | 3.00 | 3.00 |
| Corn meal | 30.68 | 33.16 | 30.68 | 33.16 | 30.68 |
| Wheat middlings | 15.00 | 15.00 | 15.00 | 15.00 | 15.00 |
| Dicalcium phosphate | 0.80 | 0.80 | 0.80 | 0.80 | 0.80 |
| C-free vitamin premix⁵ | 0.05 | 0.05 | 0.05 | 0.05 | 0.05 |
| Trace mineral premix⁵ | 0.10 | 0.10 | 0.10 | 0.10 | 0.10 |
| Vitamin C6 | 0.05 | 0.05 | 0.05 | 0.05 | 0.05 |
| Carboxymethyl | 2.00 | 2.00 | 2.00 | 2.00 | 2.00 |
| cellulose⁷ | | | | | |
| Oil | 4.00 | 2.00 | 4.00 | 2.00 | 4.00 |

¹These amounts may not add to 100% because of rounding.
²Flaxseed oil.
³Conventional soybean oil.
⁴Stearidionic acid (SDA)-enriched soybean oil.
⁵Catfish vitamin and trace mineral premixes as described by Robinson et al. (2001).
⁶Stay CJ (35% active, DSM Nutritional Products, Inc., Parsippany, NJ).
⁷Pellet binder.

DietAnalyses. Diets were analyzed for nutrient (see Table 9) and fatty acid content (see Table 10).

TABLE 9
Means¹ ± SD of dry matter, crude protein, crude fat,
and ash concentrations of catfish diets experimental diets.

| | | Dry Matter | Crude protein² | Crude fat² | Ash² |
|---|---|---|---|---|---|
| Diet number | Identity | % | % | % | % |
| 1 | 4% FSO³ | 87.60 ± 0.02 | 28.21 ± 0.02 | 5.46 ± 0.01 | 5.61 ± 0.00 |
| 2 | 2% SBO⁴ | 88.42 ± 0.01 | 28.27 ± 0.04 | 3.58 ± 0.03 | 5.65 ± 0.02 |
| 3 | 4% SBO | 89.59 ± 0.03 | 28.30 ± 0.06 | 5.60 ± 0.01 | 5.63 ± 0.01 |
| 4 | 2% SDA⁵ | 88.46 ± 0.09 | 28.18 ± 0.05 | 3.37 ± 0.01 | 5.68 ± 0.04 |
| 5 | 4% SDA | 89.07 ± 0.04 | 28.28 ± 0.02 | 5.59 ± 0.02 | 5.63 ± 0.01 |

¹Means represents duplicate samples per diet.
²As 90% dry matter basis.
³Flaxseed oil.
⁴Conventional soybean oil.
⁵Stearidonic acid (SDA)-enriched soybean oil.

TABLE 10
Means¹ ± SD of concentrations of fatty acids (mg/100 g)
in diets containing various vegetable oils.

| Fatty acids | 4% FSO¹ | 2% SBO² | 4% SBO | 2% SDA³ | 4% SDA |
|---|---|---|---|---|---|
| 14:0 | 13 ± 0 | 13 ± 0 | 15 ± 0 | 12 ± 1 | 16 ± 0 |
| 16:0 | 448 ± 3 | 437 ± 3 | 680 ± 9 | 442 ± 18 | 711 ± 16 |
| 18:0 | 212 ± 2 | 125 ± 2 | 215 ± 0 | 124 ± 2 | 221 ± 3 |
| 20:0 | 13 ± 0 | 13 ± 0 | 20 ± 1 | 13 ± 0 | 21 ± 0 |
| 22:0 | 26 ± 1 | 26 ± 0 | 34 ± 1 | 24 ± 0 | 34 ± 0 |
| 24:0 | 12 ± 0 | 11 ± 0 | 13 ± 0 | 10 ± 0 | 12 ± 0 |
| Σ saturates | 724 ± 6 | 625 ± 5 | 977 ± 7 | 625 ± 21 | 1,016 ± 20 |
| 16:1 n-7 | 23 ± 0 | 21 ± 0 | 24 ± 0 | 20 ± 1 | 25 ± 1 |
| 18:1 n-9 | 1,119 ± 20 | 771 ± 3 | 1,176 ± 4 | 711 ± 21 | 1,107 ± 15 |
| 20:1 n-9 | 17 ± 0 | 13 ± 0 | 17 ± 0 | 13 ± 2 | 19 ± 2 |
| Σ monoens | 1,159 ± 20 | 805 ± 3 | 1,218 ± 5 | 743 ± 23 | 1,151 ± 14 |
| 18:2 n-6 | 1,329 ± 25 | 1,819 ± 11 | 2,895 ± 7 | 1,317 ± 43 | 1,941 ± 20 |
| 18:3 n-6 | 0 ± 0 | 0 ± 0 | 0 ± 0 | 85 ± 2 | 195 ± 2 |
| Σ n-64 | 1,329 ± 25 | 1,819 ± 11 | 2,895 ± 7 | 1,402 ± 46 | 2,136 ± 22 |
| 18:3 n-3 | 2,133 ± 48 | 735 ± 7 | 396 ± 7 | 242 ± 7 | 491 ± 4 |
| 18:4 n-3 | 0 ± 0 | 4 ± 0 | 6 ± 0 | 300 ± 8 | 683 ± 0 |
| 20:5 n-3 | 15 ± 0 | 15 ± 0 | 15 ± 0 | 14 ± 1 | 15 ± 0 |
| 22:6 n-3 | 12 ± 1 | 12 ± 0 | 12 ± 1 | 10 ± 0 | 12 ± 0 |
| Σ n-3 | 2,160 ± 48 | 766 ± 7 | 429 ± 7 | 565 ± 15 | 1,201 ± 4 |
| Σ PUFA | 3,489 ± 73 | 2,585 ± 3 | 3,323 ± 14 | 1,968 ± 60 | 3,338 ± 26 |

¹Means represent two samples (at beginning and end of feeding) per diet.
²Flaxseed oil.
³Conventional soybean oil.
⁴Stearidonic acid (SDA)-enriched soybean oil.
⁵Other n-6 fatty acids were not determined

Water. Water temperature and dissolved oxygen were monitored daily in representative tanks using an oxygen/temperature meter. Each tank was monitored at least once per week.

Clinical observations. Mortality and behavior were observed and recorded daily.

Body weight. Fish in each aquarium were weighed at the initiation of the acclimation period and at the end of week 10 of the experimental feeding. Fish were not weighed at the initiation of experimental feeding or during the feeding period to reduce handling stress to the fish.

Survival. Any fish found dead or removed from the study and sacrificed for humane reasons were examined, and the probable cause of death or morbidity was recorded

Sample collection and storage. At the end of the experimental feeding period, all fish were sacrificed by cranial concussion followed by decapitation. Three fish were skinned and filleted. Collected skin was stored separate from the fillet to minimize cross-contamination of fats between skin and fillet. The skins and fillets were frozen at about −80° C. until fatty acid analysis was conducted. The remaining fish from each treatment group were filleted. The fillets from each fish were stored separately in sealed plastic sample bags at about −80° C. for proximate analysis and sensory evaluation. Fillets from each fish were thawed and ground into paste in a food processor before analysis and sensory evaluation.

Sensory evaluation. Remaining (up to five) fish from each of the two SDA treatments and from those fed the diet containing 4% conventional soybean oil and 4% conventional flaxseed oil were used for sensory evaluation. Sensory evaluation of fillet samples was conducted within 2 weeks post-sampling. Fish were evaluated individually on its own sensory attributes by a taste panel which consisted of six participants who were trained to taste catfish fillets. Fillet samples were randomized and identified by a numerical code that was unknown to panel members. About 100-150 g tissue from each fish was hand-formed into patties that was cooked for 70 seconds in a 1,000-watt microwave oven and immediately presented to the panelists. Each panel member recorded on the evaluation sheet the letter and numerical value that best described the overall preference and presence of fishy flavor. The following scoring system was used:
Overall Preference:
Excellent
Good
Fair
Poor
Unacceptable
Fishy Taste:
No fishy taste
Very slightly fishy
Slightly fishy
Moderate fishy
Distinct fishy

The remaining tissue (about 50 g) from each fish was used for proximate analyses (moisture, crude protein and crude fat).

Fatty acid composition. All diet and fish (up to three) samples were analyzed for fatty acid composition.

Statistics. The initial weight of fish, weight gain, feed consumption, feed conversion ratio, and proximate composition, fatty acid composition of the fillets and skins, and sensory evaluation scores of fillet samples were analyzed by one-way analysis of variance. The Fisher's protected least significant difference procedure was used to separate treatment means. Survival was analyzed using Fisher's Exact test. All statistical analyses were two-tailed at the p≦0.05 level of significance and were conducted using the Statistical Analysis System (SAS) for Windows (The SAS Institute, Cary, N.C.).

TABLE 11
Results of fatty acid analysis of the skins
Means1 ± SD of concentrations (mg/100 g raw tissue) of n-3 fatty
acids in skin samples of channel catfish fed diets containing various
vegetable oils at different concentrations for 10 weeks. Means within
a row followed by a different letter differ by analysis of variance and
Fisher's protected least significant difference procedure (P ≦ 0.05).

| Fatty acids | 4% FSO¹ | 2% SBO³ | 4% SBO | 2% SDA⁴ | 4% SDA |
|---|---|---|---|---|---|
| 18:3 n-3 | 275 ± 92 | 174 ± 36 | 162 ± 48 | 220 ± 64 | 236 ± 89 |
| 18:4 n-3 | 15 ± 10 b | 3 ± 5 b | 6 ± 5 b | 118 ± 43 a | 172 ± 66 a |
| 20:5 n-3 | 13 ± 9 b | 15 ± 5 b | 10 ± 4 b | 30 ± 10 a | 29 ± 7 a |
| 22:5 n-3 | 16 ± 11 bc | 17 ± 4 bc | 14 ± 4 c | 33 ± 11 a | 30 ± 8 ab |
| 22:6 n-3 | 30 ± 17 | 46 ± 9 | 32 ± 9 | 60 ± 14 | 58 ± 18 |
| Σ n-3 | 327 ± 124 | 255 ± 51 | 224 ± 69 | 460 ± 139 | 524 ± 188 |

¹Means represents three fish per diet except for 18:3n-3 and total n-3 fatty acids in fish fed 4% flaxseed, which had two fish (one fish was excluded because the value exceeded two SD from the mean and was considered an outlier.
²Flaxseed oil.
³Conventional soybean oil.
⁴Stearidonic acid (SDA)-enriched soybean oil.
⁵SEM = standard error of mean.

TABLE 12
Table of fatty acid analysis of the fillets
Means¹ ± SD of concentrations (mg/100 g raw tissue) of fatty
acids in fillet samples of channel catfish fed diets containing various
vegetable oils at different concentrations for 10 weeks. Means within
a row followed by different letter differ by analysis of variance and
Fisher's protected least significant difference procedure (P ≦ 0.05).

| | | | | | | Pooled | |
|---|---|---|---|---|---|---|---|
| | | | | | | SEM⁵ | |
| Fatty acids 4% FSO² | | 2% SBO³ | 4% SBO | 2% SDA⁴ | 4% SDA | N = 8 | N = 7 |
| 14:0 | 75 ± 17 | 86 ± 37 | 71 ± 22 | 74 ± 23 | 73 ± 27 | 9 | 10 |
| 16:0 | 1,530 ± 316 | 1,690 ± 674 | 1,532 ± 522 | 1,512 ± 414 | 1,621 ± 564 | 179 | 192 |
| 18:0 | 440 ± 109 | 426 ± 139 | 443 ± 137 | 424 ± 107 | 421 ± 117 | 43 | 46 |
| 20:0 | 11 ± 8 | 13 ± 8 | 12 ± 11 | 10 ± 9 | 12 ± 10 | 3 | 3 |
| Σ | 2,056 ± 433 | 2,216 ± 853 | 2,057 ± 688 | 2,020 ± 536 | 2,128 ± 707 | 231 | 247 |
| saturates | | | | | | | |
| 16:1 n-7 | 235 ± 65 | 289 ± 115 | 223 ± 80 | 250 ± 78 | 239 ± 101 | 31 | 34 |
| 18:1 n-9 | 5,256 ± 1,216 | 5,701 ± 2,032 | 5,053 ± 1,708 | 5,352 ± 1,613 | 5,487 ± 1,927 | 606 | 647 |
| 20:1 n-9 | 126 ± 28 | 156 ± 59 | 139 ± 54 | 127 ± 39 | 127 ± 52 | 17 | 18 |
| Σ | 5,617 ± 1,296 | 6,146 ± 2,206 | 5,415 ± 1,838 | 5,729 ± 1,716 | 5,854 ± 2,065 | 650 | 695 |
| monoens | | | | | | | |
| 18:2 n-6 | 1,328 ± 304 | 1,590 ± 535 | 1,789 ± 621 | 1,302 ± 364 | 1,585 ± 493 | 168 | 180 |
| 18:3 n-6 | 28 ± 14 c | 38 ± 16 bc | 40 ± 11 bc | 55 ± 17 b | 96 ± 35 a | 7 | 8 |
| Σ n-66 | 1,356 ± 316 | 1,627 ± 550 | 1,830 ± 631 | 1,357 ± 380 | 1,681 ± 527 | 174 | 186 |
| 18:3 n-3 | 786 ± 167 a | 127 ± 39 | 168 ± 62 | 142 ± 41 c | 235 ± 72 b | 32 | 34 |
| | | | bc | | | | |
| 18:4 n-3 | 21 ± 10 c | ±0 c | 0 ± 0 c | 75 ± 25 b | 180 ± 60 a | 10 | 11 |
| 20:5 n-3 | 16 ± 9 b | 3 ± 4 c | 3 ± 6 c | 18 ± 5 b | 30 ± 10 a | 3 | 3 |
| 22:5 n-3 | 24 ± 8 ab | 16 ± 4 c | 17 ± 6 bc | 21 ± 5 bc | 31 ± 11 a | 3 | 3 |
| 22:6 n-3 | 49 ± 10 ab | 34 ± 13 bc | 31 ± 12 c | 39 ± 8 bc | 59 ± 27 a | 5 | 6 |
| Σ n-3 | 896 ± 193 a | 179 ± 53 c | 220 ± 82 c | 295 ± 82 c | 535 ± 176 b | 46 | 50 |
| Σ PUFA | 2,252 ± 499 | 1,806 ± 603 | 2,049 ± 712 | 1,652 ± 461 | 2,217 ± 702 | 214 | 228 |

¹Means represents eight fish per diet except for Diet 2 which has seven fish. One fish was excluded because of low weight gain and high feed conversion ratio (exceeded two SD from mean and considered an outlier).
²Flaxseed oil.
³Conventional soybean oil.
⁴Stearidonic acid (SDA)-enriched soybean oil.
⁵SEM = standard error of mean.
⁶Other n-6 fatty acids were not determined.

TABLE 13
Sensory evaluation data
Means¹ ± SD of sensory evaluation scores. Means within a column
were not significantly different by analysis of variance (P > 0.05).

| | | Overall | |
|---|---|---|---|
| Diet number | Identity | preference² | Fishy taste³ |
| 1 | 4% FSO4 | 2.10 ± 0.25 | 1.27 ± 0.09 |
| 3 | 4% SBO5 | 1.77 ± 0.42 | 1.17 ± 0.12 |
| 4 | 2% SDA6 | 1.90 ± 0.34 | 1.30 ± 0.27 |
| 5 | 4% SDA | 1.93 ± 0.37 | 1.17 ± 0.12 |
| Pooled SEM⁷ | | 0.14 | 0.07 |

¹Means represents five fish per diet by six panelists.
²Overall preference scores: 1. Excellent 2. Good 3. Fair 4. Poor 5. Unacceptable
³Fishy taste scores: 1. No fishy taste 2. Very slightly fishy 3. Slightly fishy 4. Moderate fishy 5. Distinct fishy
⁴Flaxseed oil.
⁵Conventional soybean oil.
⁶Stearidonic acid (SDA)-enriched soybean oil.
⁷SEM = standard error of mean.

### EXAMPLE 2

### Coldwater Aquaculture Products

Purpose. The aim of this study was to determine 1) the growth performance of rainbow trout fed diets containing stearidonic acid modified soybean oil; and 2) if in the absence of dietary eicosapentaenoic acid (EPA) and docosahexaenoic acid (DHA) the additions of dietary stearidonic acid (SDA) modified soybean oil leads to increased biosynthesis and deposition of LCPUFA in rainbow trout.

Test and control oils. The test oil is soybean oil derived from soybeans containing SDA (labeled as Oil-4) containing 14.5-16.0% SDA. The control oils are soybean oil derived from a genetically similar soybean that does not contain SDA (labeled as Oil-3), conventional source of flaxseed oil (labeled as Oil-2), and a conventional source of menhaden fish oil (Oil-1). The test and control oils were stored at ˜−20° C. prior to diet preparation.

DietPreparation. Eight experimental diets were evaluated:
1) 16% menhaden fish oil+2% conventional soybean oil+de-oiled fish meal;
2) 16% conventional flaxseed oil+2% conventional soybean oil+de-oiled fish meal;
3) 18% conventional soybean oil+de-oiled fish meal;
4) 16% SDA-enriched soybean oil+2% conventional soybean oil+de-oiled fish meal;
5) 16% menhaden fish oil+fish meal containing 8% fish oil;
6) 16% conventional flaxseed oil+fish meal containing 8% fish oil;
7) 16% conventional soybean oil+fish meal containing 8% fish oil; and
8) 16% SDA-enriched soybean oil+fish meal containing 8% fish oil.

Each diet was thoroughly blended together and stored frozen (approximately −20° C.) in sealed plastic bags until fed. Diets were based on typical rainbow trout feeds, all diets were isonitrogeneous (˜40% protein), isoenergetic (˜15 MJ/kg), and isolipid (see Table 14). Diets were produced by cold pelleting. Pellet size of diets were 2 mm. Fish oil diet was prepared first followed by the flaxseed oil, control soybean oil diets, and lastly the SDA soy oil diets. The ingredient composition of the diets is presented in Table 14.

TABLE 14
The ingredient formulation (%) of experimental diets.

| | | Diets 5 to 8 |
|---|---|---|
| | Diets 1 to 4 | De-oiled fish |
| Item | Full-fat fish meal series | meal series |
| Anchovy meal (full-fat) | 25.00 | 0.00 |
| Anchovy meal (de-oiled) | 0.00 | 22.89 |
| Soybean meal | 8.00 | 8.00 |
| Soy protein concentrate | 25.00 | 25.00 |
| Wheat flour | 23.58 | 23.26 |
| Standard soy oil | 0.00 | 2.29 |
| Test oil source | 16.02 | 16.02 |
| Vitamin C | 0.30 | 0.30 |
| Choline | 0.50 | 0.50 |
| Trace mineral mix¹ | 0.10 | 0.10 |
| Vitamin premix² | 1.50 | 1.50 |
| Lysine | 0.00 | 0.10 |
| Methionine | 0.00 | 0.04 |
| Sum | 100.00 | 100.00 |

¹Composition of trace mineral mix (mg/kg): Zn (as ZnSO₄7H₂O), 75; Mn (as MnSO₄), 20; Cu (as CuSO₄5H₂O), 1.54; I (as KIO₃), 10.
²Composition of vitamin premix (mg/kg of premix, unless otherwise listed): D calcium pantothenate, 26,840; pyridoxine (pyridoxine HCl), 7,700; riboflavin, 13,200; niacinamide, 55,000; folic acid, 2,200; thiamine (thiamine mononitrate), 8,800; biotin, 88; vitamin B₁₂, 5.5; menadione sodium bisulfite complex, 2.75; vitamin E (DL α-tocopherol acetate), 88,000 IU; vitamin D₃ (stabilized), 110,000 IU; vitamin A (vitamin A palmitate, stabilized), 1,650,000 IU.

| | Diet 1 | Diet 2 | Diet 3 | Diet 4 | Diet 5 | Diet 6 | Diet 7 | Diet 8 |
|---|---|---|---|---|---|---|---|---|
| | SDA | | | | | | | |
| Soy Oil | Soy | | | | | | | |
| Oil | Flax | | | | | | | |
| Oil | Menhaden | SDA | | | | | | |
| | Oil | | | | | | | |
| Soy Oil | Soy | | | | | | | |
| Oil | Flax | | | | | | | |
| oil | Menhaden | | | | | | | |
| | Oil | | | | | | | |
| | F-F FM | F-F | F-F | F-F | D-O | D-O | D-O | D-O |
| | | FM | FM | FM | FM | FM | FM | FM |
| Moisture (%) | 5.05 | 5.10 | 5.96 | 4.14 | 5.07 | 5.01 | 5.86 | 4.78 |
| Protein (%) | 43.03 | 43.25 | 43.32 | 45.26 | 42.17 | 42.24 | 41.81 | 43.57 |
| Lipid (%) | 20.79 | 20.63 | 20.78 | 21.77 | 15.91 | 17.15 | 13.06 | 20.77 |
| Energy | 5478 | 5448 | 5331 | 5554 | 5232 | 5210 | 5211 | 5466 |
| (cal/kg) | | | | | | | | |
| Ash (%) | 8.58 | 8.70 | 8.50 | 9.10 | 8.83 | 8.87 | 8.91 | 8.58 |
| Phosphorus | 1.60 | 1.40 | 1.55 | 1.45 | 1.45 | 1.55 | 1.55 | 1.55 |
| (%) | | | | | | | | |
| Essential | | | | | | | | |
| amino acids | | | | | | | | |
| Arginine (%) | 3.24 | 3.29 | 3.22 | 3.64 | 3.31 | 3.37 | 3.34 | 3.48 |
| Histidine (%) | 0.94 | 0.95 | 0.95 | 1.05 | 0.95 | 1.00 | 0.95 | 0.99 |
| Iso-leucine | 1.67 | 1.81 | 1.76 | 1.92 | 1.79 | 1.79 | 1.78 | 1.81 |
| (%) | | | | | | | | |
| Leucine (%) | 2.97 | 3.10 | 3.02 | 3.27 | 3.06 | 3.07 | 3.04 | 3.14 |
| Lysine (%) | 2.24 | 2.34 | 2.28 | 2.54 | 2.30 | 2.35 | 2.37 | 2.50 |
| Methionine | 0.58 | 0.64 | 0.66 | 0.79 | 0.69 | 0.70 | 0.75 | 0.85 |
| (%) | | | | | | | | |
| Phenylalanine | 1.92 | 2.00 | 1.94 | 2.10 | 1.99 | 1.98 | 1.97 | 2.04 |
| (%) | | | | | | | | |
| Threonine | 1.58 | 1.65 | 1.64 | 1.77 | 1.68 | 1.70 | 1.70 | 1.73 |
| (%) | | | | | | | | |
| Valine (%) | 1.80 | 1.96 | 1.91 | 2.08 | 1.94 | 1.98 | 1.94 | 1.98 |
| Non-essential | | | | | | | | |
| amino acids | | | | | | | | |
| Alanine | 1.95 | 2.00 | 1.98 | 2.15 | 2.01 | 2.11 | 2.00 | 2.06 |
| Aspartine (%) | 3.63 | 3.74 | 3.72 | 4.03 | 3.75 | 3.80 | 3.81 | 3.86 |
| Glutamic acid | 7.00 | 7.25 | 7.09 | 7.41 | 7.13 | 7.20 | 7.21 | 7.39 |
| (%) | | | | | | | | |
| Glycine (%) | 2.13 | 2.14 | 2.13 | 2.37 | 2.17 | 2.33 | 2.19 | 2.25 |
| Proline (%) | 2.29 | 2.34 | 2.28 | 2.46 | 2.32 | 2.40 | 2.33 | 2.42 |
| Serine (%) | 1.93 | 1.97 | 1.94 | 2.06 | 1.97 | 1.99 | 2.00 | 2.06 |
| Tyrosine (%) | 1.24 | 1.27 | 1.21 | 1.47 | 1.30 | 1.33 | 1.34 | 1.43 |

Diet Analyses. Immediately following preparation, two samples (approximately 100 g each) were collected from each diet, frozen and stored at approximately 20° C. Proximate analysis of the fatty acids of the eight diet samples were conducted using standard. The second sample was frozen and kept as a retainer sample. At the first and last day of feeding from each batch of diet, approximately 100 g were taken, frozen at −20° C. and until analyzed for fatty acid analysis. Table 15 contains the nutrient composition of the diets.

TABLE 15
The analyzed nutrient composition (dry basis) of the experimental diets^{1,2}.

| | Diet 1 | Diet 2 | Diet 3 | Diet 4 | Diet 5 | Diet 6 | Diet 7 | Diet 8 |
|---|---|---|---|---|---|---|---|---|
| | SDA | Soy | Flax | Menhaden | SDA | Soy | Flax | Menhaden |
| | Soy Oil | Oil | Oil | Oil | Soy Oil | Oil | oil | Oil |
| | F-F | F-F | F-F | F-F | D-O | D-O | D-O | D-O |
| | FM | FM | FM | FM | FM | FM | FM | FM |
| C14:0 | 1.19 | 1.05 | 1.40 | 10.40 | 0.10 | 0.20 | 0.00 | 8.67 |
| C16:0 | 14.90 | 12.82 | 10.04 | 25.06 | 13.01 | 11.60 | 8.36 | 23.07 |
| C16:1 | 1.25 | 1.14 | 1.55 | 14.49 | 0.00 | 0.23 | 0.00 | 12.08 |
| C18:0 | 4.30 | 4.28 | 4.55 | 4.10 | 4.17 | 4.17 | 4.26 | 4.05 |
| C18:1 n9t | 0.00 | 0.00 | 0.00 | 0.00 | 0.00 | 0.00 | 0.00 | 0.00 |
| C18:1 | 20.27 | 21.68 | 29.22 | 13.50 | 20.67 | 22.33 | 29.78 | 15.37 |
| n9c | | | | | | | | |
| C18:2 n6t | 0.00 | 0.00 | 0.00 | 0.00 | 0.00 | 0.00 | 0.00 | 0.00 |
| C18:2 | 33.82 | 54.02 | 19.84 | 7.31 | 39.46 | 57.30 | 27.02 | 16.00 |
| n6c | | | | | | | | |
| C20:0 | 0.00 | 0.00 | 0.00 | 0.00 | 0.00 | 0.00 | 0.00 | 0.00 |
| C18:3 n6 | 4.39 | 0.00 | 0.00 | 0.00 | 4.10 | 0.00 | 0.00 | 0.00 |
| C18:3 n3 | 5.94 | 3.99 | 32.73 | 1.53 | 5.58 | 4.17 | 30.58 | 1.91 |
| C18:4 n3 | 13.94 | 0.00 | 0.00 | 3.84 | 12.91 | 0.00 | 0.00 | 3.22 |
| C20:4 n6 | 0.00 | 0.00 | 0.00 | 1.01 | 0.00 | 0.00 | 0.00 | 0.00 |
| C20:5 n3 | 0.00 | 0.00 | 0.00 | 1.97 | 0.00 | 0.00 | 0.00 | 1.65 |
| C22:5 n3 | 0.00 | 0.00 | 0.00 | 1.43 | 0.00 | 0.00 | 0.00 | 1.14 |
| C22:6 n3 | 0.00 | 1.02 | 0.67 | 15.36 | 0.00 | 0.00 | 0.00 | 12.83 |
| Sum sats | 20.39 | 18.14 | 15.99 | 39.56 | 17.28 | 15.97 | 12.62 | 35.79 |
| Sum | 21.52 | 22.82 | 30.77 | 27.99 | 20.67 | 22.56 | 29.78 | 27.45 |
| monoenes | | | | | | | | |
| Sum | 33.82 | 54.02 | 19.84 | 7.31 | 39.46 | 57.30 | 27.02 | 16.00 |
| dienes | | | | | | | | |
| Total n-3 | 19.89 | 5.02 | 33.40 | 24.13 | 18.48 | 4.17 | 30.58 | 20.76 |
| Total C18 | 19.89 | 3.99 | 32.73 | 5.37 | 18.48 | 4.17 | 30.58 | 5.14 |
| n-3s | | | | | | | | |

TABLE 16
The analyzed fatty acid composition (g/100 g fat) of the experimental
diets^{1, 2}.
¹F-F FM = full fat fish meal
²D-O FM = de-oiled fish meal

### Test System:

Twelve hundred rainbow trout (Oncorhynchus mykiss), a domesticated strain (House Creek strain, from College of Southern Idaho) weighing approximately 10 g each were used. Fish were housed in 24, 200-L fiberglass tanks (three replicates per treatment) with 50 fish per tank. Each tank was supplied with spring water at a flow rate of approximately 8 liter per minute of untreated, constant temperature (14.5±1° C.) water. Dissolved oxygen was at least 6 mg/liter. Fish were maintained on a fixed 14-hour light/10-hour dark cycle controlled by timers and fluorescent lights.

Experimental Design: A 4×2 factorial experiment was utilized. The first factor was oils source with menhaden oil providing EPA and DHA, standard soybean oil providing LA, stearidonic acid modified soybean oil providing SDA, and flax oil providing ALA. The inclusion of menhaden oil as a positive control enabled a direct performance comparison against plant oils containing only the EPA and DHA precursors. The second factor was fish meal type with standard fish meal (fish meal containing about 8% fish oil) or oil extracted fish meal. The inclusion of the oil extracted fish meal series ensured that the oil component of the fishmeal did not contribute significant amounts of essential fatty acids for rainbow trout. Parameters evaluated were survival, body weight gain, feed conversion, whole body proximate composition and whole body fatty acid profile. The diets (8), fish (27) and skins (24) were analyzed for fatty acids.

TABLE 17
Group Designations. The following groups were included in this study:

| | | Dietary Level of | |
|---|---|---|---|
| Identity | Description | Added oil1 | Fish Meal Type |
| Diet 1 | Oil-1 | 18% | Oil extracted |
| Diet 2 | Oil-2 | 18% | Oil extracted |
| Diet 3 | Oil-3 | 18% | Oil extracted |
| Diet 4 | Oil-4 | 18% | Oil extracted |
| Diet 5 | Oil-1 | 18% | Standard |
| Diet 6 | Oil-2 | 18% | Standard |
| Diet 7 | Oil-3 | 18% | Standard |
| Diet 8 | Oil-4 | 18% | Standard |

1Dietary level of added oil includes that from fish meal, Oil-1, Oil-2, Oil-3, Oil-4, and conventional soy oil.

Acclimation. A group of fish was obtained from the hatchery held in the research facility for a period of two weeks prior to the stocking of the experiment. Fish were fed a commercial diet (40% protein, 20% lipid) and visually monitored for disease symptoms. The healthy looking fish were stocked into the experimental system and fed their respective experimental diets the following day.

Assignment to Treatment Groups. After acclimation, 24 tanks (three rows of eight tanks each) were selected for experimental feeding. Each of the eight (8) treatments were assigned at random to the eight tanks in each of three rows with each tank containing 50 fish (mean weight of approximately 10 g).

Feeding. Eight groups of rainbow trout (3 tanks per group, 50 fish per tank) were fed by hand three times per day, six days per week to apparent satiation for a period of 16 weeks at which point they approached 200 to 250 g/fish. Feed intake was determined weekly.

Observations. Water temperature and dissolved oxygen was monitored in each tank once per week. Mortality and behavior were observed and recorded daily. Feeding activity of the fish and feed consumption were recorded. Each tank was bulk-weighed and fish counted at the beginning of the test period and at the end of weeks 4, 8, 12 and 16.

Sample Collection and Analysis. Fifteen fish (pooled into 3 samples of 5 fish) from the initial population, and 5 fish from each of 24 tanks (5 fish/tank pooled to give 24 samples) at the end of the experiment, were collected for whole body proximate composition and whole body fatty acid analyses. Dietary ingredients, diets and whole fish and fish skins were analyzed. Fish were processed into a puree and sub-sampled for whole body proximate composition and whole body fatty acid profile.

### Data Analysis

Statistics. Data were analyzed for statistical significance with 2-factor analysis of variance (ANOVA) using Statistica, Version 6.1 software (StatSoft, Inc., Tulsa, Okla.). A significance level of P<0.05 was used, and tank mean values were considered units of observation for statistical analysis. If appropriate, post-hoc tests were used to identify significant differences between treatments.

The fatty acid composition of the whole fish is presented in Table 18.

TABLE18
The fatty acid composition (g/100 g fat) of rainbow trout fed experimental diets for 16 weeks^{1, 2, 3}.

| | Diet 1 | Diet 2 | Diet 3 | Diet 4 | Diet 5 | Diet 6 | Diet 7 | Diet 8 | |
|---|---|---|---|---|---|---|---|---|---|
| | SDA | Soy | Flax | Menhaden | SDA | Soy | Flax | Menhaden | Probability |
| | Soy Oil | Oil | Oil | Oil | Soy Oil | Oil | oil | Oil | value |
| | F-F FM | F-F FM | F-F FM | F-F FM | D-O FM | D-O FM | D-O FM | D-O FM | (P) |
| C14:0 | 1.13^{c} | 1.19^{c} | 1.28^{c} | 6.95^{a} | 0.54^{de} | 0.42^{e} | 0.64^{d} | 5.99^{b} | <0.0001 |
| C16:0 | 12.72^{bc} | 12.81^{bc} | 10.98^{cd} | 18.00^{a} | 13.35^{b} | 10.72^{d} | 11.96^{bcd} | 18.66^{a} | <0.0001 |
| C16:1 | 1.67^{c} | 1.80^{c} | 1.68^{c} | 12.79^{a} | 1.03^{de} | 0.63^{e} | 1.15^{d} | 10.03^{b} | <0.0001 |
| C18:0 | 3.95^{cd} | 4.33^{bc} | 4.74^{b} | 3.59^{d} | 4.67^{b} | 3.92^{cd} | 5.40^{a} | 4.14^{bcd} | 0.0005 |
| C18:1 n9c | 18.90^{cd} | 22.09^{abcd} | 25.49^{abc} | 14.31^{d} | 21.01^{bcd} | 31.91^{a} | 30.14^{ab} | 17.60^{cd} | 0.0134 |
| C18:2 n6c | 28.94^{b} | 44.80^{a} | 15.33^{d} | 6.62^{e} | 32.42^{b} | 42.74^{a} | 21.46^{c} | 14.79^{d} | <0.0001 |
| C18:3 n6 | 7.75^{a} | 1.23^{b} | 0.166^{b} | 0.250^{b} | 3.77^{ab} | 1.21^{b} | 0.00^{b} | 0.00^{b} | 0.0141 |
| C18:3 n3 | 4.01^{c} | 3.03^{cd} | 21.39^{a} | 2.03^{d} | 3.89^{c} | 2.42^{cd} | 19.64^{b} | 2.03^{d} | <0.0001 |
| C18:4 n3 | 10.17^{a} | 0.81^{d} | 2.75^{bc} | 2.88^{b} | 9.59^{a} | 0.58^{d} | 3.49^{b} | 2.07^{c} | <0.0001 |
| C20:2 | 0.58^{bc} | 1.44^{a} | 0.47^{bc} | 0.53^{bc} | 0.68^{b} | 1.45^{a} | 0.21^{cd} | 0.00^{d} | <0.0001 |
| C20:3 n6 | 1.35^{b} | 1.05^{c} | 0.27^{d} | 0.26^{d} | 1.68^{a} | 1.35^{b} | 0.00^{e} | 0.00^{e} | <0.0001 |
| C20:3 n3 | 0.00^{c} | 0.02^{c} | 0.82^{a} | 0.29^{b} | 0.00^{c} | 0.00^{c} | 0.40^{b} | 0.00^{c} | <0.0001 |
| C20:4 n6 | 0.41^{de} | 0.82^{b} | 0.29^{e} | 1.15^{a} | 0.54^{cd} | 0.66^{c} | 0.00^{f} | 0.39^{de} | <0.0001 |
| C22:2 | 2.55^{a} | 0.13^{e} | 1.93^{bc} | 2.49^{a} | 2.14^{b} | 0.00^{e} | 1.51^{d} | 1.84^{c} | <0.0001 |
| C20:5 n3 | 0.95^{cd} | 0.51^{e} | 0.97^{c} | 6.80^{a} | 0.72^{de} | 0.00^{f} | 0.53^{e} | 5.25^{b} | <0.0001 |
| C22:5 n3 | 0.40^{c} | 0.16^{d} | 0.39^{c} | 2.19^{a} | 0.30^{c} | 0.00^{e} | 0.00^{e} | 1.58^{d} | <0.0001 |
| C22:6 n3 | 4.52^{cd} | 3.75^{de} | 5.19^{c} | 18.86^{a} | 3.69^{e} | 1.98^{fc} | 3.48^{e} | 15.65^{b} | <0.0001 |

¹F-F FM = full fat fish meal
²D-O FM = de-oiled fish meal
³Means (n = 3) in the same row that share the same superscript are not statistically different (P > 0.05; One-factor ANOVA; Tukey HSD test).
Analysis of the fatty acid composition of the whole fish provides insight into the improved fatty acid compositions that would be expected to be observed in fish derivatives such as fish oil and fish meal, wherein substantial portions of the fish are used rather than just the fillets which are the primary meat source for human consumption. As can be seen above, the proportion of each of the various fatty acids differs significantly when the fish are fed diets comprising stearidonic acid. In for example, increased levels of SDA, GLA, and DGLA are observed. Furthermore, increased ratios of concentration such as for example GLA/LA are also observed.

These unique compositions and fatty acid ratios are expected to provide unique fish derivative compositions such as fish oils and fish meals which also have unique characteristics. Benefits of feeding these unique meals and oils are expected to propagate through the feeding cycle through multiple generations as SDA-comprising feed is fed to a first generation of fish, then fish derivatives are fed to a second generation of fish, and a second generation of fish derivatives are fed to a third generation of fish, and so on.

### EXAMPLE 3

### Crustacean Products

The objectives of this study were to determine: 1) the growth performance of Pacific white shrimp fed diets containing stearidonic acid (SDA) modified soybean oil, with and without replacement of fish meal with soybean meal; 2) the level of fish oil replacement that can be made with SDA-modified soybean oil; 3) omega-3 fatty acid enrichment in shrimp meat; and 4) the sensory characteristics of the shrimp meat.

### Test and Control Oils.

The test oil was soybean oil derived from soybeans containing 28-30% stearidonic acid (SDA 18:4 ω3) labeled as Oil-1. The control oil was a conventional source of menhaden fish oil (labeled as Oil-2). The menhaden oil was stabilized at the point of production with Ethoxyquin (500 ppm). The SDA soybean oil was stabilized with 500 ppm (by weight) at the research site. Approximately 1 ml samples of each of Oil-1 and Oil-2 were taken and stored at ˜−20° C. until fatty acid analysis and diet preparation.

### Protein Sources.

Commercial sources of fish meal (stabilized by the manufacturer with Ethoxyquin) and dehulled soybean meal were used. Approximately 50 g samples of each of fish meal and dehulled soybean meal were taken and stored at −20° C. prior to fatty acid characterization.

### Storage.

The test and control substances will be stored at −20° C. prior to diet preparation.

### Shrimp Diets.

Six experimental diets were formulated (38.6% crude protein, 8.8% ether extract) and evaluated. The six diets were described as:
1) Diet 1: Ratio of fish meal to dehulled soybean meal (100:0), 3.20% fish oil, 0% SDA soy oil (Control)
2) Diet 2: Ratio of fish meal to dehulled soybean meal (50:50), 4.45% fish oil, 0% SDA soy oil
3) Diet 3: Ratio of fish meal to dehulled soybean meal (0:100), 5.70% fish oil, 0% SDA soy oil
4) Diet 4: Ratio of fish meal to dehulled soybean meal (100:0), 0% fish oil, 3.20% SDA soy oil
5) Diet 5: Ratio of fish meal to dehulled soybean meal (50:50), 0% fish oil, 4.45% SDA soy oil
6) Diet 6: Ratio of fish meal to dehulled soybean meal (0:100), 0% fish oil, 5.70% SDA soy oil

Six test diets (see Table 20) were based on the control diet but with 100, 50 and 0% of the fish meal replaced by dehulled solvent extracted soybean meal 48 cp product (substitutions were made on a protein basis, to keep dietary protein content equal) incorporating either fish oil or SDA soy oil. The difference in amount of fish meal or soybean meal was made by altering the wheat starch component. Diets 1 and 4, diets 2 and 5, and diets 3 and 6 were iso-lipidic.

Particle size analysis of dry ingredient mix for each diet was determined. Each diet was be thoroughly blended together and stored frozen (−20° C.) in sealed plastic bags until fed. Six (6) shrimp diets were agglomerated into 2.4 mm pellets with no steam-conditioning of the mash; pellets were dried in a Forced Air Despatch oven at 100° C. for 8 min, cooled by ambient air and stored frozen (−20° C.) in sealed plastic bags until fed.

Diets were based on typical shrimp feeds, all diets were isonitrogeneous, isoenergetic, and isolipidic (with differing oil types). Fish oil diets were prepared first followed by SDA soy oil diets in increasing oil content. Immediately following preparation, two samples (100 g each) were collected from each diet, frozen and stored at 20° C. Proximate, gross energy, amino acid, fatty acid, and mineral analysis of 7 ingredients (1. Menhaden fish meal; 2. dehulled soybean meal; 3) wheat; 4) wheat gluten; 5) brewer's yeast; 6) squid meal; and 7) wheat starch) and six diet samples were conducted.

Test System. Five thousand Pacific white shrimp (Litopenaeus vannamei) selected for uniformity and weighing approximately 1-2 g each were used. Shrimp were housed in 24, 1300 L OML fiberglass tanks with 100 shrimp per tank. The OML tanks were modified to be similar to the ICL system with each tank supplied with flow-though seawater from a well. The tanks were covered to block out sunlight to limit natural productivity on the sides of the tanks or in the water column. Tanks were provided with aeration from a ring diffuser. Each tank was supplied with water at a flow rate of approximately 3 L /min of untreated, constant temperature (26±0.5° C.) water from an on-site seawater well. Dissolved oxygen was at least 4 mg/liter, generally above 5 mg/liter. Shrimp were maintained outdoors under natural photoperiod, but the tanks were covered.

Experimental Design. The trial was conducted as a completely randomized design with six treatments and four replicate groups of shrimp assigned to each treatment. All data were submitted to ANOVA procedures followed by planned comparisons of select treatment means. The contrasts included the planned comparisons of treatments Diet 1 versus Diet 4, Diet 2 versus Diet 5 and Diet 3 versus Diet 6. Parameters evaluated included survival, body weight gain, feed conversion, tail muscle proximate composition and energy value, tail muscle fatty acid profile and sensory characteristics. The oil (2), ingredients (7), diets (6), and shrimp tail muscle (28) were analyzed for fatty acids. The following groups were included in this study:

TABLE 19
Oil and meal composition of experimental shrimp feeds.

| | | Dietary Level of | Fish Meal:Soybean |
|---|---|---|---|
| Identity | Description | Added oil | Meal |
| Diet 1 | Fish oil | 3.20% | 100:0 |
| Diet 2 | Fish oil | 4.45% | 50:50 |
| Diet 3 | Fish oil | 5.70% | 0:100 |
| Diet 4 | SDA Soy oil | 3.20% | 100:0 |
| Diet 5 | SDA Soy oil | 4.45% | 50:50 |
| Diet 6 | SDA Soy oil | 5.70% | 0:100 |

Shrimp acclimated for a period of 1 week prior to the stocking of the experiment. During this period, they were fed a commercial diet (35% cp/2.5 squid, 8% lipid) and visually monitored for general health. Only healthy looking shrimp were stocked into the experimental system. Shrimp were selected for uniformity and weighed in groups of 25 (to the nearest 0.1 g) until a density of 100 shrimp/tank was achieved in each tank, approximately 54 animals/m2.

Each tank of shrimp were fed by hand 3 times daily, 7 days per week to apparent satiation for a period of about 14-16 weeks. Initial ration portion was determined by a feeding chart, after which portion size was adjusted daily based on the presence or absence of uneaten diet. The amount of diet remaining from the previous night's feeding was determined by visual inspection each morning. If excess diet remained (>10 pellets), the portion size was reduced by 5%; if no diet remained, portion size was increased by 5%; and, if little diet remained (<10 pellets), there was no change in portion size. Following the daily inspection, all tanks were cleaned of uneaten diet, molts and fecal material by siphoning and flushing.

Observations. Water temperature, dissolved oxygen, salinity were monitored for each tank twice daily, while total ammonia nitrogen (TAN), nitrite, and pH wee monitored in one tank per treatment once per week and water and air flow rates in each tank once per week. Mortality and behavior were observed and recorded daily. The amount of diet fed to each tank was recorded daily. The shrimp in each tank were bulk-weighed and counted at the beginning of the test period and at the end of weeks 4, 8, 12, 14 and 16 or until market size was achieved. Any shrimp found dead or moribund was removed from the study and examined, and the probable cause of death or morbidity was recorded. Survival of was calculated from the number of shrimp remaining at the end of the trial.

Sample Collection and Analysis. Twenty shrimp (pooled into 4 samples of 5 shrimp) from the initial population, and 5 shrimp from each of the 24 tanks (four samples of 5 shrimp from each treatment) at the end of the experiment, were collected for tail muscle proximate composition and tail muscle fatty acid analyses. Dietary ingredients, diets and shrimp tail meat (edible portion) were analyzed for chemical composition. Shrimp tail muscle was processed into a puree and subsampled for proximate composition and fatty acid profile.

Sensory Evaluation. Sensory analysis was conducted using a trained panel, which utilized a paired comparison test or a 9-point hedonic scale to determine if there were differences in the following treatments: TRT1 vs TRT4; TRT2 vs TRT5; TRT3 vs TRT6. The taste and spit procedure was used. Shrimp samples were cooked at 177° C. for 8-12 minutes depending on size and quantity of shrimp. The cooked shrimp were chilled for 20 minutes, then peeled and stored on ice or refrigerated (˜30 minutes) until served to the panel. The results were subjected to appropriate statistical procedures using SigmaStat (v3.5) statistical computer software.

Results. The shrimp fed diets comprising SDA incorporated SDA into the tissues of the shrimp. SDA-containing soy oil was a complete replacement for fish oil when fed in combination with fish meal. No adverse taste effects were observed in the sensory panel. Details of the results can be seen in Tables 20 through 25 below.

TABLE 20
Formulations of diets used to examine the ability of steariodonic acid (SDA)
enriched soybean oil to replace menhaden fish oil for shrimp. Soybean meal
was included at three levels of fishmeal replacement (0, 50 and 100%),
while supplemental oil was provided by fish oil (FO) or SDA soybean oil.

| | 0SBMFO | 50SBMFO | 100SBMFO | 0SBMSDA | 50SBMSDA | 100SBMSDA |
|---|---|---|---|---|---|---|
| Ingredient | % | % | % | % | % | % |
| Fish meal¹ | 38.30 | 19.15 | 0.00 | 38.30 | 19.15 | 0.00 |
| Soybean meal | 0.00 | 28.70 | 57.50 | 0.00 | 28.70 | 57.50 |
| Wheat flour² | 37.73 | 26.98 | 16.13 | 37.73 | 26.98 | 16.13 |
| Wheat gluten | 6.00 | 6.00 | 6.00 | 6.00 | 6.00 | 6.00 |
| Brewers yeast | 5.00 | 5.00 | 5.00 | 5.00 | 5.00 | 5.00 |
| Squid meal | 4.00 | 4.00 | 4.00 | 4.00 | 4.00 | 4.00 |
| SDA oil | 0.00 | 0.00 | 0.00 | 3.00 | 4.20 | 5.40 |
| Fish oil | 3.00 | 4.20 | 5.40 | 0.00 | 0.00 | 0.00 |
| Soy lecithin | 2.00 | 2.00 | 2.00 | 2.00 | 2.00 | 2.00 |
| Vitamin premix | 0.40 | 0.40 | 0.40 | 0.40 | 0.40 | 0.40 |
| Mineral premix | 0.06 | 0.06 | 0.06 | 0.06 | 0.06 | 0.06 |
| Choline chloride | 1.20 | 1.20 | 1.20 | 1.20 | 1.20 | 1.20 |
| Vitamin C³ | 0.08 | 0.08 | 0.08 | 0.08 | 0.08 | 0.08 |
| Calcium | 2.00 | 2.00 | 2.00 | 2.00 | 2.00 | 2.00 |
| phosphate | | | | | | |
| Cholesterol | 0.23 | 0.23 | 0.23 | 0.23 | 0.23 | 0.23 |

¹Menhaden meal. Omega Protein, Co. (Special Select)
²Whole red hard winter wheat.
³Stay C-35 (35% AA potency)

TABLE 21
Weight, growth, feed conversion ratio (FCR) and survival of shrimp
fed diets containing three levels of fishmeal replacement by soybean
meal, with and without replacement of fish oil by SDA enriched soy
oil for 12 weeks. Values are means of four observations.

| | Fishmeal | | Weight | Growth | FCR | Survival |
|---|---|---|---|---|---|---|
| Diet | replacement | Oil Source | (g) | (g/wk) | (g/g) | (%) |
| 1 | 0 | FO | 20.3 | 1.55 | 2.12 | 90.5 |
| 2 | 50 | FO | 20.5 | 1.57 | 2.20 | 92.8 |
| 3 | 100 | FO | 18.7 | 1.42 | 2.05 | 88.3 |
| 4 | 0 | SDA | 21.1 | 1.62 | 2.05 | 91.8 |
| 5 | 50 | SDA | 19.3 | 1.46 | 1.97 | 89.5 |
| 6 | 100 | SDA | 16.1 | 1.20 | 2.15 | 89.0 |
| SEM¹ | | | 0.44 | 0.036 | 0.058 | 2.07 |
| Fishmeal | | | S² | S | NS | NS |
| Oil | | | S | S | NS | NS |
| Source | | | | | | |
| FM*OS | | | S | S | S | NS |

¹Standard Error of Means
²S = Significant; NS = Non significant (alpha = 0.05)

TABLE 22
Planned comparisons of weight, growth, feed conversion ratio
(FCR) and survival of shrimp fed diets containing three levels of
fishmeal replacement by soybean meal, with and without
replacement of fish oil by SDA enriched soy oil for 12 weeks.

| | Fishmeal | | Weight | Growth | FCR | Survival |
|---|---|---|---|---|---|---|
| Diet | replacement | Oil Source | (g) | (g/wk) | (g/g) | (%) |
| 1 | 0 | FO | 20.3 | 1.55 | 2.12 | 90.5 |
| 2 | 50 | FO | 20.5 | 1.57 | 2.20 | 92.8 |
| 3 | 100 | FO | 18.7 | 1.42 | 2.05 | 88.3 |
| 4 | 0 | SDA | 21.1 | 1.62 | 2.05 | 91.8 |
| 5 | 50 | SDA | 19.3 | 1.46 | 1.97 | 89.5 |
| 6 | 100 | SDA | 16.1 | 1.20 | 2.15 | 89.0 |
| SEM¹ | | | 0.44 | 0.036 | 0.058 | 2.07 |
| Fishmeal | | | S² | S | NS | NS |
| Oil | | | S | S | NS | NS |
| Source | | | | | | |
| FM*OS | | | S | S | S | NS |

TABLE 23
Sensory characteristics of shrimp fed diets containing 100% FM and
0% SBM with 3.20% FO (Treatment 1) and 3.20% SDA (Treatment 4).
Values are means ± SD of 32 observations for each sensory attribute.
Values in a row with the same letters are not significantly
different at P < 0.05.

| | | Cooked |
|---|---|---|
| | Cooked shrimp tail | shrimp tail |
| | muscle fed FO | muscle fed SDA |
| Sensory Attributes | (Treatment 1) | (Treatment 4) |
| Odor/Smell | | |
| Intensity (1 = mild, 9 = strong) | 2.88 ± 0.39a | 2.69 ± 0.68a |
| Off-odor (1 = none, 9 = strong) | 1.03 ± 0.10a | 1.09 ± 0.26a |
| Appearance | | |
| Color (1 = light, 9 = dark) | 3.34 ± 0.32a | 3.47 ± 0.73a |
| Texture | | |
| Firmness (1 = tender, 9 = firm) | 4.88 ± 0.53a | 4.75 ± 0.92a |
| Moistness (1 = dry, 9 = moist) | 5.92 ± 0.28a | 5.95 ± 0.47a |
| Fattiness (1 = lean, 9 = fatty) | 3.77 ± 0.19a | 3.80 ± 0.54a |
| Flavor | | |
| Intensity (1 = mild, 9 = strong) | 4.45 ± 0.53a | 4.33 ± 0.70a |
| Sweetness (1 = none, 9 = | 4.66 ± 0.54a | 4.73 ± 0.69a |
| sweet) | | |
| Earthiness (1 = none, 9 = | 1.00 ± 0.00a | 1.07 ± 0.20a |
| earthy) | | |
| Off-flavor (1 = none, 9 = | 1.00 ± 0.00a | 1.07 ± 0.23a |
| strong) | | |

FM = fishmeal;
SBM = soybean meal;
FO = fish oil;
SDA = stearidonic acid

TABLE 24
Sensory characteristics of shrimp fed diets containing 50% FM and
50% SBM with 4.45% FO (Treatment 2) and 4.45% SDA (Treatment 5).
Values are means ± SD of 32 observations for each sensory attribute.
Values in a row with the same letters are not significantly
different at P < 0.05.

| | | Cooked |
|---|---|---|
| | Cooked shrimp tail | shrimp tail |
| | muscle fed FO | muscle fed SDA |
| Sensory Attributes | (Treatment 2) | (Treatment 5) |
| Odor/Smell | | |
| Intensity (1 = mild, 9 = strong) | 2.72 ± 0.20a | 2.56 ± 0.48a |
| Off-odor (1 = none, 9 = strong) | 1.01 ± 0.04a | 1.01 ± 0.05a |
| Appearance | | |
| Color (1 = light, 9 = dark) | 3.24 ± 0.44a | 3.26 ± 0.78a |
| Texture | | |
| Firmness (1 = tender, 9 = firm) | 5.00 ± 0.55a | 5.03 ± 0.95a |
| Moistness (1 = dry, 9 = moist) | 6.13 ± 0.32a | 5.96 ± 0.84a |
| Fattiness (1 = lean, 9 = fatty) | 3.88 ± 0.33a | 3.92 ± 0.59a |
| Flavor | | |
| Intensity (1 = mild, 9 = strong) | 4.59 ± 0.31a | 4.50 ± 0.71a |
| Sweetness (1 = none, 9 = | 4.86 ± 0.52a | 4.89 ± 0.77a |
| sweet) | | |
| Earthiness (1 = none, 9 = | 1.00 ± 0.00a | 1.06 ± 0.20a |
| earthy) | | |
| Off-flavor (1 = none, 9 = | 1.00 ± 0.00a | 1.04 ± 0.18a |
| strong) | | |

FM = fishmeal;
SBM = soybean meal;
FO = fish oil;
SDA = stearidonic acid

TABLE 25
Sensory characteristics of shrimp fed diets containing 0% FM and 100%
SBM with 5.70% FO (Treatment 3) and 5.70% SDA (Treatment 6).
Values are means ± SD of 32 observations for each sensory attribute.
Values in a row with the same letters are not significantly
different at P < 0.05.

| | | Cooked |
|---|---|---|
| | Cooked shrimp tail | shrimp tail |
| | muscle fed FO | muscle fed SDA |
| Sensory Attributes | (Treatment 3) | (Treatment 6) |
| Odor/Smell | | |
| Intensity (1 = mild, 9 = strong) | 2.69 ± 0.23a | 2.58 ± 0.39a |
| Off-odor (1 = none, 9 = strong) | 1.00 ± 0.00a | 1.00 ± 0.00a |
| Appearance | | |
| Color (1 = light, 9 = dark) | 3.41 ± 0.37a | 3.43 ± 0.55a |
| Texture | | |
| Firmness (1 = tender, 9 = firm) | 4.97 ± 0.40a | 5.04 ± 0.81a |
| Moistness (1 = dry, 9 = moist) | 6.15 ± 0.44a | 6.03 ± 0.79a |
| Fattiness (1 = lean, 9 = fatty) | 3.87 ± 0.32a | 3.85 ± 0.64a |
| Flavor | | |
| Intensity (1 = mild, 9 = strong) | 4.77 ± 0.36a | 4.62 ± 0.66a |
| Sweetness (1 = none, 9 = | 4.95 ± 0.40a | 4.75 ± 0.67a |
| sweet) | | |
| Earthiness (1 = none, 9 = | 1.00 ± 0.00a | 1.00 ± 0.00a |
| earthy) | | |
| Off-flavor (1 = none, 9 = | 1.00 ± 0.00a | 1.00 ± 0.00a |
| strong) | | |

FM = fishmeal;
SBM = soybean meal;
FO = fish oil;
SDA = stearidonic acid

### REFERENCES

The references cited in this application, both above and below, are specifically incorporated herein by reference.
1. AOAC, 1990. Official Methods of Analysis of the Association of Official Analytical Chemists, (fifteenth edit. Eds: Association of Official Analytical Chemists, Inc. Arlington, Va.) (pp. 1298).
2. Bell, J. G., Tocher, D. R., Henderson, R. J., Dick, J. R. and Crampton, V. O., (2003). Altered Fatty acid compositions in Atlantic salmon (Salmo salar) fed diets containing linseed and rapeseed oils can be partially restored by a subsequent fish oilfin ishing diet. JOURNAL OF NUTRITION, 133, 2793-2801.
3. Bell J G, Stracham F, Good J E, Tocher D R. (2006) Effect of dietary echium oil on growth, fatty acid composition, and metabolism, gill prostaglandin production, and macrophage activity in Atlantic Cod. AQUACULTURE RESEARCH, 2006, 37, 606-617
4. Calder, P. C. and Field, C. J. (2002). Fatty Acids, Inflammation and Immunity. IN: NUTRITION AND IMMUNE FUNCTION, (P. C. Calder, C. J. Field and H. S. Gill (Eds)). CABI Publishing. pp: 57-92.
5. Bendiksen, E., Berg, O, K., Jobling, M.; Arnesen, A. M. and Masoval, K., (2003). Digestibility, growth and nutrient utilisation of Atlantic salmon parr (Salmo salar L.) in relation to temperature, feedfat content and oil source. AQUACULTURE 224, pp. 283-299.
6. Fracalossi, D. M. and R. T. lovell. (1994). Dietary lipid sources influence responses of channel catfish (Ictalurus punctatus) to challenge with pathogen Edwardsiella ictaluri. AQUACULTURE 119:287-298.
7. Ghioni, C., Porter, A. E. A., Taylor, G. W. and Tocher, D. R., (2004). Metabolism of 18:4-n3 (stearidonic acid) and 20:4-n3, in salmonid cells in culture and inhibition and production of prostaglandin F2a (PGF2a) from arachidonic acid (20:4-n6), FISH PHYSIOLOGY AND BIOCHEMISTRY 27, 81-96.
8. Ghioni, C., Tocher, D. R., Bell, M. V., Dick, J. R. and Sargent, J. R., (1999). Low C18 to C20 fatty acid elongase activity and limited conversion of stearidonic acid (18:4(n3), to eicosapentaenoic acid, 20:5(n3), in a cell line from the turbot, Scopthalmus maximus. BIOCHEM BIOPHYS. ACTA 25, 1437(2), 170-181.
9. Hardy, R. W., (2002). Rainbow trout, Oncorhynchus mykiss. IN: NUTRIENT REQUIREMENTS AND FEEDING OF AQUACULTURE FISH (Edited by C. D. Webster & C. Lim) CAB International Publishers, New York, pp. 184-202.
10. Harris W S, DiRienzo M A, Sands S A, George C, Jones P G, and Eapen, A K (2007) Stearidonic Acid Increases the Red Blood Cell and Heart Eicosapentaenoic Acid Content in Dogs, LIPIDS 42:325-333.
11. James, M. J., Ursin, V. M. and Cleland, L. G., (2003). Metabolism of stearidonic acid in human subjects: comparison with other metabolism of other n-3 fatty acids. AM. J. CLIN. NUTR. 77, 1140-1145.
12. Klasing, K. C. and Leshchinsky, T. V., (2000), Interactions Between Nutrition And Immunity. Lessons From Animal Agriculture. IN: NUTRITION AND IMMUNOLOGY: PRINCIPLES AND PRACTICE. (M. E. Gershwin, J. B. Germanand, C. L. Keen (Eds)). Elsevier. pp: 363-373.
13. Krokhan H E, Bjerve K S, Mork E. 1993. The enteral bioavailability of eicosapentaenoic acid and docosahexaenoic acid is as goodfrom ethyl esters as from glyceryl esters in spite of lower hydrolytic rates by pancreatic lipase in vitro. BIOCHIM BIOPHYS ACTA, (1993) May 20;1 168(1):59-67.
14. Manuela Martinez, Elida Vázquez, M Teresa García-Silva, Javier Manzanares, José M Bertran, Francisco Castelló and Isabel Mougan. (2000). Therapeutic effects of docosahexaenoic acid ethyl ester in patients with generalized peroxisomal disorders. AMERICAN JOURNAL OF CLINICAL NUTRITION, Vol. 71, No. 1, 376S-385S.
15. Manning, Bruce B. Enrichment of channel catfish (Icatalurus punctatus) fillets with conjugated linoleic acid and omega-3 fatty acids by dietary manipulation. (2006) AQUACULTURE, 261: 337-342.
16. Mattos R., C R Staples, and W W Thatcher, Effects of Dietary Fatty Acids on Reproduction In Ruminants, (2000), REVIEWS OF REPRODUCTION 5:38-45.
17. Miles E A, Banerjee T, Calder, P C (2004) The influence of different combinations of gamma-linolenic acid, stearidonic acid and EPA on immune function in healthy young male subjects. BR J NUTR. June 2004;91(6):893-903.
18. Miller, M. R., P. D. Nichols, and C. G. Carter. (2007). Replacement of dietary fish oil for atlantic salmon parr (Salmo salar L.) with a stearidonic acid containing oil has no effect on omega-3 long-chain polyunsaturated fatty acid concentrations. COMP BIOCHEM AND PHYSIOL PART B 146:197-206.
19. Mugrditchian, D. S., Hardy, R. W. and Iwaoka, W. T., (1981). Linseed oil and animal fat as alternative lipid sources in dry diets for Chinook salmon (Oncorhynchus tshawytscha). AQUACULTURE, 25, 161-172.
20. Meyer A., H. Kirsch, F. Domergue, A. Abbadi, P. Sperling, J. Bauer, P. Cirpus, T. K. Zank, H. Moreau, T. J. Roscoe, U. Zahringer, and E. Heinz. (2004). Novel fatty acid elongases and their use for the reconstitution of docosahexaenoic acid biosynthesis. JOURNAL OF LIPID RESEARCH 45: 1899-1909.
21. Napier, Johnathan. (2007) The Production of Unusual Fatty Acids in Transgenic Plants. ANNU. REV. PLANT BIOL., 2007 58:295-319.
22. National Research Council (NRC), (1993). Nutrient Requirement of Fish. Committee on Animal Nutrition, Board of Agriculture, National Research Council. National Academic Press, Washington, D.C. p. 114
23. Regost, C., Arzel, J., Robin, J., Rosenlund, G. and Kaushik, S. J., (2003). Total replacement offish oil by soybean or linseed oil with a return to fish oil in turbot (Psetta maxima). 1. Growth performance, flesh fatty acid profile, and lipid metabolism. AQUACULTURE 217, 465-482.
24. Sargent, J. R, Tocher, D. R. and Bell, J. G., (2002). The lipids. In: Fish Nutrition 2nd Edition, Halver, J. E. & Hardy, R. W., Editors. Academic Press, New York, pp. 181-257.
25. Storebakken, T. (2002). Atlantic salmon, Salmo salar, In: Nutrient Requirements and Feeding of Aquaculture Fish (Edited by C. D. Webster & C. Lim) CAB International Publishers, New York, pp. 79-102.
26. Sun-Young Lim and Hiramitsu Suzuki. (2000), Intakes of Dietary Docosahexaenoic Acid Ethyl Ester and Egg Phosphatidylcholine Improve Maze-Learning Ability in Young and Old Mice. JOURNAL OF NUTRITION. 2000;130:1629-1632.
27. Tacon, A. G. J. (1988). The nutrition and feeding of farmed fish and shrimp—A training manual. 3. Feeding methods. FAO GCP/RLA/075/ITA Field Document 7/E http:/www.fao.org/docrep/field/003/ab467e/AB467E00.HTM
28. Tocher T. R., Dick J. R., MacGlaughlin P., Bell (2006) Effect of diets enriched in Δ6 desaturated fatty acids (18:3n-6 and 18:4n-3), on growth, fatty acid composition and highly unsaturated fatty acid synthesis in two populations of Arctic charr (Salvelinus alpinus L.), Comparative Biochemistry and Physiology, Part B 144 (2006) 245-253
29. Ursin. (2003), Modification of plant lipids for human health: Development of functional land-based omega-3 fatty acids. J. NUTR. 133:4271-4274.
30. Webster, C. D. and C. Lim, INTRODUCTION TO FISH NUTRITION, IN: NUTRIENT REQUIREMENTS AND FEEDING OF AQUACULTURE FISH (Edited by C. D. Webster & C. Lim) CAB International Publishers, New York, (pp. 1-27)(2002)

What is claimed is:

1. An aquaculture meat product comprising tissue from an aquatic animal having stearidonic acid (“SDA”), eicosapentaenoic acid (“EPA”), gamma linolenic acid (“GLA”) and docosahexaenoic acid (“DHA”) wherein:
a. The concentration of SDA is at least about 25 mg/100 g in the tissue of said aquatic animal;
b. the concentration of said GLA is at least about 25 mg/100 g in the tissue of said aquatic animal;
c. the concentration of said EPA is at least about 15 mg/100 g in the tissue of said aquatic animal; and,
d. the concentration of said DHA is at least about 30 mg/100 g tissue in the tissue of said aquatic animal.

2. The aquaculture meat product of claim 1, further comprising dihomogamma-linolenic acid (“DGLA”).

3. The aquaculture meat product of claim 1, wherein the ratio of concentrations of GLA/SDA is at least about 0.5.

4. The aquaculture meat product of claim 1 wherein the ratio of concentrations of DGLA/SDA is at least about 0.1.

5. The aquaculture meat product of claim 1 wherein the ratio of concentrations of EPA/SDA is less than about 1.

6. The aquaculture meat product of claim 1 further comprising tocochromanol.

7. The aquaculture meat product of claim 1 wherein said aquaculture animal is selected from the group consisting of a fish and a crustacean.

8. A method of producing an aquaculture product comprising:
a. providing a stearidonic acid source comprising stearidonic acid (SDA);
b. providing additional feed components;
c. contacting said stearidonic acid source with said feed components to make a supplemented feed;
d. feeding said supplemented feed to a plurality of aquatic animals; and,
e. harvesting at least one edible product from said aquatic animals,
wherein said stearidonic acid source comprises a transgenic plant source and wherein at least a portion of said SDA is incorporated into said edible product.

9. The method according to claim 8, wherein said stearidonic acid transgenic plant source comprises seeds and/or oil selected from the group of plants consisting of soybeans, canola, and corn.

10. The method according to claim 8 wherein said stearidonic acid source comprises oil derived from a portion of a transgenic plant.

11. The method according to claim 8 further comprising fatty acids, wherein the total fatty acids in the supplemented feed comprise at least about 0.5% SDA.

12. The method according to claim 8, wherein said aquaculture product is selected from the group consisting of fish meat, shrimp meat, fish oil or fish meal.

13. The method according to claim 8, wherein said stearidonic acid source further comprises tocochromanol.

14. The method of claim 8 wherein said SDA source further comprises GLA.

15. The method of claim 14 wherein the ratio of concentrations of SDA/GLA is at least about 1.5.

16. The method of claim 8, wherein the omega-3 to omega-6 fatty acid ratio of the stearidonic acid source is greater than about 1:2.

17. The method of claim 8, wherein said stearidonic acid source further comprises at least about 0.01% of an acid, wherein the acid is selected from the group consisting of 6-cis, 9-cis, 12-cis, 15-trans-octadecatetraenoic acid; 9-cis, 12-cis, 15-trans-alpha linolenic acid; and 6,9-octadecadienoic acid.

18. The method of claim 8 wherein said aquatic animal is a fish.

19. The method of claim 8 wherein said aquatic animals are contained in an artificial environment.

20. The method of claim 8 where said feeding occurs on multiple occasions over a period of at least seven days.

21. A fish derivative comprising stearidonic acid (SDA), eicosapentaenoic acid (EPA), gamma linolenic acid (GLA) and docosahexaenoic acid (DHA) wherein:
a. The concentration of SDA is at least about 3.0 g/100 g fatty acids;
b. the concentration of said GLA is at least about 1.5 g/100 g fatty acids;
the concentration of said EPA is at least about 0.5 g/100 g fatty acids; and
d. the concentration of said DHA is at least about 3.0 g/100 g fatty acids.

22. The fish derivative of claim 21 wherein said fish derivative is selected from the group consisting of a fish oil and a fish meal.

23. The fish derivative of claim 21 wherein said fish derivative is derived from a fish fed feed comprising SDA and GLA and wherein said ration of SDA/GLA in said fish feed is at least about 1.0.

24. The fish derivative of claim 21 wherein said feed further comprises transgenic soybean oil.

25. The fish derivative of claim 21 wherein the SDA concentration is at least about 4.0 g/100 g fatty acids.

26. The fish derivative of claim 21, wherein the GLA concentration is at least about 1.5 g/100 g fatty acids.

27. The fish derivative of claim 21 further comprising DGLA.

28. The fish derivative of claim 21 wherein the ratio of concentrations of GLA/SDA is at least about 0.5.

29. The fish derivative of claim 27 wherein the ratio of concentrations of DGLA/SDA is at least about 0.1.

30. The fish derivative of claim 21 wherein the ratio of concentrations of EPA/SDA is at less than about 1

31. The fish derivative of claim 21 further comprising tocochromanol.

32. A method of producing an aquaculture product comprising:
a. providing a fish derivative;
b. feeding said fish derivative to a plurality of aquaculture animals; and,
c. harvesting at least one aquaculture product from said aquaculture animals; and,
wherein said fish derivative is an oil or meal derived from a fish which is fed feed comprising stearidonic acid from a transgenic plant source.

33. The method of claim 32 wherein said fish derivative is selected from the group consisting of a fish oil and a fish meal.

34. The method of claim 32 wherein said aquaculture product is selected from the group consisting of fish meat, fish meal, and fish oil.

35. The method of claim 32 wherein said fish derivative comprises SDA, GLA, EPA, DHA, and DGLA.

36. The method of claim 35 wherein the concentration of SDA in said fish derivative is at least about 3 g/100 g fatty acids.

37. The method of claim 35 wherein the concentration of GLA in said fish derivative is at least about 1 g/100 g fatty acids.

38. The method of claim 35 wherein the concentration of DGLA in said fish derivative is at least about 0.3 g/100 g fatty acids.

39. The method of claim 35 wherein the ratio of concentrations of SDA/GLA is between 1.0 and 4.0.

40. The method of claim 32 further comprising contacting said fish derivative with a source of stearidonic acid.
